(19) United States
(12) Patent Application Publication
(10) Pub. No.: US 2018/0352844 A1
(43) Pub. Date: Dec. 13, 2018

(54) METHODS OF MAKING AN ORGANIC DIETARY SUPPLEMENT

(71) Applicant: Elite One Source Nutritional Services, Inc., Missoula, MT (US)

(72) Inventor: Hunter Hickes, Lolo, MT (US)

(21) Appl. No.: 16/002,777

(22) Filed: Jun. 7, 2018

Related U.S. Application Data
(60) Provisional application No. 62/624,147, filed on Jan. 31, 2018.
(60) Provisional application No. 62/516,856, filed on Jun. 8, 2017.

(51) Int. Cl. A23L 33/105; A23L 33/175; A23L 33/16; A23L 33/15; A23L 33/12

(52) U.S. Cl. CPC A23L 33/105; A23L 33/175; A23L 33/16; A23L 33/15; A23V 2200/208; A23V 2002/00; A23V 2200/21; A23V 2250/5028; A23V 2250/51086; A23L 33/12

(57) ABSTRACT

Methods for manufacturing organic dietary supplements are provided. The method comprises adding an aqueous granulating solution to an organic dietary supplement formulation to improve compressibility of the supplement, wherein the aqueous granulating solution comprises organic gum arabic. The process for preparing an organic dietary supplement and improving its compressibility and flowability is also provided. Methods for manufacturing non-organic dietary supplements are further provided.

This application claims priority to, and the benefit of, co-pending U.S. Provisional Application No. 62/516,856, filed Jun. 8, 2017, and U.S. Provisional Application No. 62/624,147, filed Jan. 31, 2018, for all subject matter common to both applications. The disclosure of said provisional application is hereby incorporated by reference in its entirety.

### FIELD OF THE INVENTION

The present invention relates to methods of manufacturing organic dietary supplements, namely methods of improving the compressibility and flowability characteristics of such supplements.

### BACKGROUND OF THE INVENTION

The dietary supplement industry is constantly evolving. Recent marketing and consumer trends have moved away from traditional, synthetic sources of dietary or nutritional supplementation towards more naturally-derived foods. Organic sources of vitamins and minerals are becoming increasingly appealing in the marketplace. Because of this, there is a need to design manufacturing processes that are truly organic-compliant to supply this consumer demand.

Traditional nutraceutical and pharmaceutical excipients (e.g. binders, fillers, flow aids, lubricants, etc.) used to produce common solid dosage form supplements (tablets and capsules) are not permitted in organic products. Now, there are no standard alternatives for these excipients that have the same level of functionality and wide-spread use. Table 1 shows a list of many commonly-used excipients that are not allowed to be used in the manufacture of organic products.

Excipients Commonly Used in the Nutraceutical and Pharmaceutical Industries include the following:

TABLE 1

| Excipient | Function |
|---|---|
| Silicon Dioxide | Flow Aid, moisture scavenger |
| Microcrystalline Cellulose | Binder, diluent |
| Dicalcium Phosphate | Binder, diluent |
| Directly Compressible Calcium | Binder, diluent |
| Carbonate | |
| Croscarmellose Sodium | Disintegrant |
| Magnesium Stearate | Lubricant |
| Stearic Acid | Lubricant |
| Talc | Lubricant, flow aid |
| Sugar Alcohols (Mannitol, Sorbitol, | Sweetener, binder in |
| Xylitol, etc) | chewable tablets |

Compounding this problem is the fact that many, if not most, organic active ingredients do not have ideal physical characteristics for pressing into tablets via direct compression manufacturing processes. The critical active materials in the products that will be used as case studies in this report (organically-derived vitamin and mineral extracts) have a fine particle size distribution. The abundance of fine and ultra-fine particles in these materials makes them flow poorly and exhibit limited compressibility. It is possible that the physical properties of these raw materials may be modified by utilizing extra processing steps such as dry or wet granulation. However, these processes add significant cost and time to the manufacturing process, which in turn reduces the commercial viability of these organic tablet products.

The instant invention addresses these and other needs by providing a process that overcomes many of the hurdles encountered when making Organic tablets. The process involves introduction of a 0.7-1.0% w/w granulating solution consisting of 18% gum Arabic and 82% water by using an intensifier-bar liquid addition assembly that comes with a Patterson-Kelley liquids/solids twin shell v-blender. This invention additionally provides a more cost effective solution for manufacturing organic tablets that have improved compressibility and flowability as compared to organic tablets manufactured by current and traditional means.

### BRIEF SUMMARY OF THE INVENTION

According to aspects of the invention illustrated herein, there is provided a method of manufacturing an organic dietary supplement, comprising adding an aqueous granulating solution to an organic dietary supplement formulation, wherein the aqueous granulating solution comprises organic gum arabic.

According to aspects of the invention illustrated herein, there is provided a process of preparing an organic dietary supplement comprising: (A) preparing an aqueous granulating solution by dissolving about 18% weight of the total composition of gum arabic in an acceptable solvent or water; (B) adding the aqueous granulating solution of Step A to a dry blend of ingredients, and forming a granulate; (C) blending the granulate from Step B with a disintegrant, a binder, a glidant, a lubricant, and an anti-caking agent; and (D) compressing the final granulation from step C into a tablet.

According to aspects of the invention illustrated herein, there is provided a method of improving compressibility of an organic dietary supplement, comprising adding an aqueous granulating solution to an organic dietary supplement formulation at beginning of manufacturing, wherein the aqueous granulating solution comprises organic gum arabic.

According to aspects of the invention illustrated herein, there is provided a method of improving flowability of an organic dietary supplement, comprising adding an aqueous granulating solution to an organic dietary supplement formulation at beginning of manufacturing, wherein the aqueous granulating solution comprises organic gum arabic.

According to aspects of the invention illustrated herein, there is provided a method of manufacturing a non-organic dietary supplement, comprising adding an aqueous granulating solution to the non-organic dietary supplement formulation to improve compressibility of the supplement, wherein the aqueous granulating solution comprises hydroxypropylcellulose (HPC).

### BRIEF DESCRIPTION OF THE DRAWINGS/FIGURES

FIG. 1 shows the compressibility of blends of organic women's multivitamin tablet without the addition of the aqueous granulating solution.

FIG. 2 shows the flowability of blends of organic women's multivitamin tablet without the addition of the aqueous granulating solution.

FIG. 3 shows the compressibility of M175130 with and without the addition of the aqueous granulating solution.

FIG. 4 shows the flowability of M175130 with and without the addition of the aqueous granulating solution.

FIG. 5 shows the compressibility of organic women's multivitamin tablet blends with and without the addition of the aqueous granulating solution.

FIG. 6 shows the flowability of organic women's multivitamin tablet blends with and without the addition of the aqueous granulating solution.

FIG. 7 shows the compressibility of organic men's plus multivitamin tablet without the addition of the aqueous granulating solution.

FIG. 8 shows the flowability of organic men's plus multivitamin tablet without the addition of the aqueous granulating solution.

FIG. 9 shows the compressibility of organic men's plus multivitamin tablet with and without the addition of the aqueous granulating solution.

FIG. 10 shows the flowability of organic men's plus multivitamin tablet with and without the addition of the aqueous granulating solution.

FIG. 11 shows the compressibility of blends of Immune Boost Chewable Tablet without the addition of the aqueous granulating solution.

FIG. 12 shows the compressibility of Immune Boost Chewable Tablet with and without the addition of the aqueous granulating solution.

FIG. 13 shows the compressibility of production blends of Testosterone Boosting Tablet with the addition of the aqueous granulating solution.

### DETAILED DESCRIPTION OF THE INVENTION

### I. Definitions

As used herein, the term “organic” means a product is made in conformity with the U.S. national standard for organic products known as the National Organic Program (NOP), codified in the U.S. Code of Federal Regulations at 7 CFR Part 2015, which is herein incorporated by reference. To be “organic”, dietary supplements must be manufactured using ingredients that are certified “organic” by the U.S.D.A. Accredited. Certifying Agents for the National Organic Program established in accordance with the Organic Foods Production Act of 1990 (7 U.S.C. 6501 et seq.). Ingredients that are certified “organic” must also comply with processing standards for growing, storing, processing, packaging and shipping to avoid synthetic chemicals, genetically modified organisms, irradiated materials and sewage sludge.

As used herein, the term “essential nutrients” refers to vitamins, dietary minerals, essential fatty acids, and essential amino acids.

As used herein, the term “vitamin” means an organic compound required by an organism as a vital nutrient in limited amounts. The thirteen recognized vitamins include Vitamin A, Vitamin B1, Vitamin B2, Vitamin B3, Vitamin B5, Vitamin B6, Vitamin B7, Vitamin B12, Vitamin C, Vitamin D, Vitamin E, and Vitamin K.

As used herein, the term “mineral” means a chemical element required by a living organism, other than the four elements carbon, hydrogen, nitrogen, and oxygen present in common organic molecules. Minerals include calcium, phosphorous, potassium, sulfur, sodium, chlorine, magnesium, iron, cobalt, copper, zinc, molybdenum, iodine, and selenium.

As used herein, the term “essential fatty acid” means a fatty acid that humans and other animals must ingest because the body requires it for good health but cannot synthesize it. Essentials fatty acids include alpha-linolenic acid (an omega-3 fatty acid), linolenic acid (an omega-6 fatty acid), docosahexaenoic acid (an omega-3 fatty acid), and gamma-linolenic acid (an omega-6 fatty acid).

As used herein, the term “essential amino acid” means an amino acid that cannot be synthesized de novo (from scratch) by the organism, and thus must be supplied in its diet. The nine amino acids humans cannot synthesize are phenylalanine, valine, threonine, tryptophan, methionine, leucine, isoleucine, lysine, and histidine (i.e., F V T W M L I K H).

As used herein, the term “active ingredient” refers the ingredient in a pharmaceutical drug that is biologically active.

As used herein, the term “active pharmaceutical ingredient” is any substance or mixture of substances intended to be used in the manufacture of a medicinal/drug product and that becomes an active ingredient of the drug product.

As used herein, the term “excipient” is a substance formulated alongside the active ingredient of a medication to facilitate processing or to provide the medicine with desired performance measures. Excipients may include, but are not limited to, bulking agents, fillers, diluents, flavoring agents, coloring agents, lubricants, glidants, sorbants, preservatives, sweeteners, wetting agents, emulsifiers, solvents. The selection of appropriate excipients also depends upon the route of administration and the dosage form, as well as the active ingredient and other factors.

### II. Organic Dietary Supplements

The present invention relates to the manufacturing of dietary supplements. In one embodiment, the present invention relates to the manufacturing of organic dietary supplements. In another embodiment, the present invention relates to the manufacturing of non-organic dietary supplements. As used herein, the term “dietary supplements” can refer to both organic and non-organic dietary supplements. Organic dietary supplements are dietary supplements that may be marketed with organic labeling, as long as they satisfy certain requirements, namely they 1) contain agricultural products such as herbs or vitamins and minerals derived from plants, and 2) comply with the National Organic Program (NOP) regulation. The dietary supplements of the present invention may be formulated in a dosage form selected from a tablet, a pill, a capsule, a caplet, a troche, a sachet, a cachet, a pouch, sprinkles, or any other form suitable for oral administration.

In general, to qualify as an “organic” supplement, the supplements must contain at least 95% organic ingredients (by weight). The remaining ingredients do not need to be organic but they, nevertheless, need to be approved by the NOP. Ingredients that are certified “organic” are those that do not contain any artificial flavoring, coloring or chemical preservative or any other artificial or synthetic ingredient. Moreover, “organic” ingredients are only subjected to minimal processing. Minimal processing may include traditional processes used to make a product edible or to preserve it or to make it safe for human consumption (e.g., smoking, roasting, freezing, drying or fermenting), or other physical processes which do not fundamentally alter the raw product and/or which only separate a whole intact food into component parts (e.g., grinding, separating, pressing).

Excluded from the category of certified “organic” ingredients are most of the commonly employed tablet excipients including silicon dioxide, microcrystalline cellulose, cellulose derivatives, starch derivatives, polyvinylpyrrolidone, dicalcium phosphate, directly compressible calcium carbonate, croscarmellose sodium, magnesium stearate, stearic acid, talc, sugar alcohols such as mannitol, sorbitol, xylitol, other synthetic or highly processed lubricants and disintegrants.

Ingredients that are suitable excipients for certified “organic” labeling include, but are not limited to, dextrose, inulin, soy fiber, oat fiber, guar gum, gum arabic, locust bean gum, and gum acacia. An important feature of the present invention is gum arabic. gum arabic, also known as acacia gum, is a natural gum consisting of the hardened sap of various species of the acacia tree. gum arabic is of vegetable origin and is readily digested and assimilated by animals. It does not support growth for molds or bacteria which often contaminate food products. Gum acacia is a complex mixture of glycoproteins and polysaccharides which give it the properties of a glue and binder that is edible by humans. It remains an important ingredient in soft drink syrup and “hard” gummy candies such as gumdrops, marshmallows, and M&M's chocolate candies. It is also soluble in water, and a high concentration can be obtained without increasing the viscosity substantially.

Active dietary supplements that may be formulated with the certified “organic” excipients and compressed into tablets in accordance with one embodiment of this invention include those materials identified or defined as dietary supplements by 21 U.S.C. § 321. In general, such active ingredients include various nutrients including vitamins, minerals, herbs, or other botanicals, essential amino acids, essential fatty acids, and dietary substances used to supplement the diet by increasing the total dietary intake. Also included are concentrates, metabolites, constituents, extracts and combinations thereof of the above-referenced vitamins, minerals, herbs, or other botanicals, essential amino acids, essential fatty acids, and dietary substances for increasing the total dietary intake.

In general, the choice and amount of active ingredient, binder, diluent, disintegrant and/or lubricant may be selected so that the tablets can be made for a large variety of nutritionally active organic ingredients, with other changes involving granulation to control particle size, and/or the addition of an agent to control flow.

In an embodiment, the organic dietary supplement may include an active ingredient. In an embodiment, the active ingredient may include, but are not limited to, vitamins, minerals, herbs, or other botanicals, essential amino acids, essential fatty acids, dietary substances, and combinations thereof. In a women's multivitamin, for example, the active ingredients may include, Orgen Him Plus®, organic moringa leaf extract, organic wrightia herb extract, organic lantana herb extract, organic curry leaves extract, vitamin K1 renatured, vitamin B12 renatured 207 m, vitamin D3, vitamin K2, organic veggie blend, organic fruit blend, and beta carotene veg beadlets. A men's 40 plus multivitamin may include, in another example, Orgen Him Plus®, organic sea kelp, vitamin K1 renatured, vitamin B12 renatured 207 m, vitamin D3, vitamin K2, organic moringa leaf extract, organic wrightia herb extract, organic lantana herb extract, organic pomegranate juice pwd, organic tomato powder, organic turmeric powder, organic pumpkin powder, organic veggie blend, organic fruit blend, and beta carotene veg beadlets.

In another embodiment of the invention, the organic dietary supplement may include a binder. The binder is added to increase the mechanical strength of the granules and tablets during formation. In other words, a binder is added to impart sufficient hardness to the tablet. Binders can be added to the formulation in different ways: (1) as a dry powder, which is mixed with other ingredients before wet agglomeration, (2) as a solution, which is used as agglomeration liquid during wet agglomeration, and is referred to as a solution binder, and (3) as a dry powder, which is mixed with the other ingredients before compaction. In this form the binder is referred to as a dry binder. Solution binders are a common way of incorporating a binder into granules. In certain embodiments, the binder used in the formulation is in the form of a dry powder binder. Examples of organic binders include those based on organic gums, such as Prehydrated® TICorganic® Gum Arabic SF supplied by Texture Innovation Center, White Marsh, Md. In an embodiment, the binder is included in an amount between about 2.0 wt % and about 8.0 wt % of the formulation. In an embodiment, the binder is included in an amount between about 2.0 wt % and about 2.5 wt % of the formulation. In an embodiment, the binder is included in an amount between about 2.5 wt % and about 3.0 wt % of the formulation. In an embodiment, the binder is included in an amount between about 3.0 wt % and about 3.5 wt % of the formulation. In an embodiment, the binder is included in an amount between about 3.5 wt % and about 4.0 wt % of the formulation. In an embodiment, the binder is included in an amount between about 4.0 wt % and about 4.5 wt % of the formulation. In an embodiment, the binder is included in an amount between about 4.5 wt % and about 5.0 wt % of the formulation. In an embodiment, the binder is included in an amount between about 5.0 wt % and about 5.5 wt % of the formulation. In an embodiment, the binder is included in an amount between about 5.5 wt % and about 6.0 wt % of the formulation. In an embodiment, the binder is included in an amount between about 6.0 wt % and about 6.5 wt % of the formulation. In an embodiment, the binder is included in an amount between about 6.5 wt % and about 7.0 wt % of the formulation. In an embodiment, the binder is included in an amount between about 7.0 wt % and about 7.5 wt % of the formulation. In an embodiment, the binder is included in an amount between about 7.5 wt % and about 8.0 wt % of the formulation. In an embodiment, the binder is included in an amount of about 3.95 wt % of the formulation.

In an embodiment, the binder is included in an amount between about 2.0 wt % and about 4.5 wt % of the formulation. In an embodiment, the binder is included in an amount between about 2.5 wt % and about 4.5 wt % of the formulation. In an embodiment, the binder is included in an amount between about 3.0 wt % and about 4.5 wt % of the formulation. In an embodiment, the binder is included in an amount between about 3.5 wt % and about 4.5 wt % of the formulation. In an embodiment, the binder is included in an amount between about 2.0 wt % and about 5.0 wt % of the formulation. In an embodiment, the binder is included in an amount between about 2.5 wt % and about 5.0 wt % of the formulation. In an embodiment, the binder is included in an amount between about 3.0 wt % and about 5.0 wt % of the formulation. In an embodiment, the binder is included in an amount between about 3.5 wt % and about 5.0 wt % of the formulation. In an embodiment, the binder is included in an amount between about 4.0 wt % and about 5.0 wt % of the formulation. In an embodiment, the binder is included in an amount between about 4.5 wt % and about 5.0 wt % of the formulation.

In an embodiment, the binder is included in an amount of about 3.95 wt % of the formulation. In another embodiment, the binder is included in an amount of about 3.0 wt %, 3.25 wt %, 3.5 wt %, 3.75 wt %, 4.0 wt %, 4.25 wt %, or 4.5 wt %.

In another embodiment, the binder is included in an amount of about 2.0 wt % to about 8.0 wt %, or from 2.5 wt % to 7.0 wt %, or 3.0 wt % to 6.0 wt %, or 3.5 wt % to 5.0 wt %, or from 3.75 wt % to 4.0 wt %.

In a further embodiment, the binder is included in an amount of about 3.95 wt %±1.0 wt %, 3.95 wt %±0.5 wt %, 3.95 wt %±0.75 wt %, or of about 3.95 wt %±0.25 wt %.

In an alternative embodiment, the binder is included in an amount of about 2 wt % to 4 wt %, 2 wt % to 5 wt %, 4 wt % to 6 wt %, 5 wt % to 7 wt %, or 6 wt % to 8 wt %. In another embodiment, the binder is included in an amount of about 3.5 wt % to 8 wt %, 3.5 wt % to 7 wt %, 3.5 wt % to 6 wt %, 3.5 wt % to 5 wt %, or 3.5 wt % to 4 wt %.

Examples of non-organic binders include HPC, dicalcium phosphate anhydrous, and Dextrose Cantab® (JRS Pharma). In an embodiment, the non-organic binder is included in an amount between about 2.0 wt % and about 8.0 wt % of the formulation. In an embodiment, the non-organic binder is included in an amount between about 2.0 wt % and about 2.5 wt % of the formulation. In an embodiment, the non-organic binder is included in an amount between about 2.5 wt % and about 3.0 wt % of the formulation. In an embodiment, the non-organic binder is included in an amount between about 3.0 wt % and about 3.5 wt % of the formulation. In an embodiment, the non-organic binder is included in an amount between about 3.5 wt % and about 4.0 wt % of the formulation. In an embodiment, the non-organic binder is included in an amount between about 4.0 wt % and about 4.5 wt % of the formulation. In an embodiment, the non-organic binder is included in an amount between about 4.5 wt % and about 5.0 wt % of the formulation. In an embodiment, the non-organic binder is included in an amount between about 5.0 wt % and about 5.5 wt % of the formulation. In an embodiment, the non-organic binder is included in an amount between about 5.5 wt % and about 6.0 wt % of the formulation. In an embodiment, the non-organic binder is included in an amount between about 6.0 wt % and about 6.5 wt % of the formulation. In an embodiment, the non-organic binder is included in an amount between about 6.5 wt % and about 7.0 wt % of the formulation. In an embodiment, the non-organic binder is included in an amount between about 7.0 wt % and about 7.5 wt % of the formulation. In an embodiment, the non-organic binder is included in an amount between about 7.5 wt % and about 8.0 wt % of the formulation. In another embodiment, the non-organic binder is included in an amount between about 2.0 wt % and about 30.0 wt % of the formulation.

In an embodiment, the non-organic binder is included in an amount between about 2.0 wt % and about 4.5 wt % of the formulation. In an embodiment, the non-organic binder is included in an amount between about 2.5 wt % and about 4.5 wt % of the formulation. In an embodiment, the non-organic binder is included in an amount between about 3.0 wt % and about 4.5 wt % of the formulation. In an embodiment, the non-organic binder is included in an amount between about 3.5 wt % and about 4.5 wt % of the formulation. In an embodiment, the non-organic binder is included in an amount between about 2.0 wt % and about 5.0 wt % of the formulation. In an embodiment, the non-organic binder is included in an amount between about 2.5 wt % and about 5.0 wt % of the formulation. In an embodiment, the non-organic binder is included in an amount between about 3.0 wt % and about 5.0 wt % of the formulation. In an embodiment, the non-organic binder is included in an amount between about 3.5 wt % and about 5.0 wt % of the formulation. In an embodiment, the non-organic binder is included in an amount between about 4.0 wt % and about 5.0 wt % of the formulation. In an embodiment, the non-organic binder is included in an amount between about 4.5 wt % and about 5.0 wt % of the formulation.

In an embodiment, the non-organic binder is included in an amount of about 3.95 wt % of the formulation. In another embodiment, the non-organic binder is included in an amount of about 3.0 wt %, 3.25 wt %, 3.5 wt %, 3.75 wt %, 4.0 wt %, 4.25 wt %, or 4.5 wt %.

In another embodiment, the non-organic binder is included in an amount of about 2.0 wt % to about 8.0 wt %, or from 2.5 wt % to 7.0 wt %, or 3.0 wt % to 6.0 wt %, or 3.5 wt % to 5.0 wt %, or from 3.75 wt % to 4.0 wt %.

In a further embodiment, the non-organic binder is included in an amount of about 3.95 wt %±1.0 wt %, 3.95 wt %±0.5 wt %, 3.95 wt %±0.75 wt %, or of about 3.95 wt %±0.25 wt %.

In an alternative embodiment, the non-organic binder is included in an amount of about 2 wt % to 4 wt %, 2 wt % to 5 wt %, 4 wt % to 6 wt %, 5 wt % to 7 wt %, or 6 wt % to 8 wt %. In another embodiment, the binder is included in an amount of about 3.5 wt % to 8 wt %, 3.5 wt % to 7 wt %, 3.5 wt % to 6 wt %, 3.5 wt % to 5 wt %, or 3.5 wt % to 4 wt %.

As used herein, the term “anti-caking agent” means an ingredient that prevents excessive agglomeration of the in-process mix that might hamper proper agitation and uniform distribution of the ingredients. Examples of organic anti-caking agents include organic rice concentrates, such as Nu-Flow® supplied by Ribus, Inc. of St. Louis, Mo. In an embodiment, the anti-caking agent is included in an amount between about 0.5 wt % and about 3.0 wt % of the formulation. In an embodiment, the anti-caking agent is included in an amount between about 0.5 wt % and about 1.0 wt % of the formulation. In an embodiment, the anti-caking agent is included in an amount between about 1.0 wt % and about 1.5 wt % of the formulation. In an embodiment, the anti-caking agent is included in an amount between about 1.5 wt % and about 2.0 wt % of the formulation. In an embodiment, the anti-caking agent is included in an amount between about 2.0 wt % and about 2.5 wt % of the formulation. In an embodiment, the anti-caking agent is included in an amount between about 2.5 wt % and about 3.0 wt % of the formulation. In an embodiment, the anti-caking agent is included in an amount of about 1.0% of the formulation.

In an embodiment, the anti-caking agent is included in an amount between about 0.50 wt % and about 1.5 wt % of the formulation. In an embodiment, the anti-caking agent is included in an amount between about 0.70 wt % and about 1.5 wt % of the formulation. In an embodiment, the anti-caking agent is included in an amount between about 0.90 wt % and about 1.5 wt % of the formulation. In an embodiment, the anti-caking agent is included in an amount between about 0.95 wt % and about 1.5 wt % of the formulation. In an embodiment, the anti-caking agent is included in an amount between about 0.50 wt % and about 1.3 wt % of the formulation. In an embodiment, the anti-caking agent is included in an amount between about 0.5 wt % and about 1.1 wt % of the formulation. In an embodiment, the anti-caking agent is included in an amount between about 0.5 wt % and about 2.0 wt % of the formulation. In an embodiment, the anti-caking agent is included in an amount between about 1.0 wt % and about 3.0 wt % of the formulation.

In an embodiment, the anti-caking agent is included in an amount of about 1.0 wt % of the formulation. In another embodiment, the anti-caking agent is included in an amount of about 0.70 wt %, 0.80 wt %, 0.90 wt %, 0.95 wt %, 1.1 wt %, 1.3 wt %, or 1.5 wt %.

In another embodiment, the anti-caking agent is included in an amount of about 0.5 wt % to about 1.50 wt %, or from 0.75 wt % to 1.25 wt %, or 0.90 wt % to 1.50 wt %, or 0.95 wt % to 2.0 wt %, or from 0.97 wt % to 3.0 wt %.

In a further embodiment, the anti-caking agent is included in an amount of about 1.0 wt %±1.0 wt %, 1.0 wt %±0.5 wt %, 1.0 wt %±0.75 wt %, or of about 1.0 wt %±0.25 wt %.

In an alternative embodiment, the anti-caking agent is included in an amount of about 0.25 wt % to 2 wt %, 0.50 wt % to 2.25 wt %, 0.75 wt % to 2.50 wt %, 0.90 wt % to 2.75 wt %, or 0.97 wt % to 3.0 wt %. In another embodiment, the anti-caking agent is included in an amount of about 0.60 wt % to 2.0 wt %, 0.70 wt % to 2.2 wt %, 0.80 wt % to 2.4 wt %, 0.90 wt % to 2.6 wt %, or 0.98 wt % to 2.80 wt %.

Examples of non-organic anti-caking agents include silicon dioxide. In an embodiment, the non-organic anti-caking agent is included in an amount between about 0.5 wt % and about 3.0 wt % of the formulation. In an embodiment, the non-organic anti-caking agent is included in an amount between about 0.5 wt % and about 1.0 wt % of the formulation. In an embodiment, the non-organic anti-caking agent is included in an amount between about 1.0 wt % and about 1.5 wt % of the formulation. In an embodiment, the non-organic anti-caking agent is included in an amount between about 1.5 wt % and about 2.0 wt % of the formulation. In an embodiment, the non-organic anti-caking agent is included in an amount between about 2.0 wt % and about 2.5 wt % of the formulation. In an embodiment, the non-organic anti-caking agent is included in an amount between about 2.5 wt % and about 3.0 wt % of the formulation.

In an embodiment, the non-organic anti-caking agent is included in an amount between about 0.50 wt % and about 1.5 wt % of the formulation. In an embodiment, the non-organic anti-caking agent is included in an amount between about 0.70 wt % and about 1.5 wt % of the formulation. In an embodiment, the non-organic anti-caking agent is included in an amount between about 0.90 wt % and about 1.5 wt % of the formulation. In an embodiment, the non-organic anti-caking agent is included in an amount between about 0.95 wt % and about 1.5 wt % of the formulation. In an embodiment, the non-organic anti-caking agent is included in an amount between about 0.50 wt % and about 1.3 wt % of the formulation. In an embodiment, the non-organic anti-caking agent is included in an amount between about 0.5 wt % and about 1.1 wt % of the formulation. In an embodiment, the non-organic anti-caking agent is included in an amount between about 0.5 wt % and about 2.0 wt % of the formulation. In an embodiment, the non-organic anti-caking agent is included in an amount between about 1.0 wt % and about 3.0 wt % of the formulation.

In an embodiment, the non-organic anti-caking agent is included in an amount of about 1.00 wt % of the formulation. In another embodiment, the non-organic anti-caking agent is included in an amount of about 0.70 wt %, 0.80 wt %, 0.90 wt %, 0.95 wt %, 1.10 wt %, 1.30 wt %, or 1.5 wt %.

In another embodiment, the non-organic anti-caking agent is included in an amount of about 0.5 wt % to about 1.50 wt %, or from 0.75 wt % to 1.25 wt %, or 0.90 wt % to 1.50 wt %, or 0.95 wt % to 2.0 wt %, or from 0.97 wt % to 3.0 wt %.

In a further embodiment, the non-organic anti-caking agent is included in an amount of about 1.0 wt %±1.0 wt %, 1.0 wt %±0.5 wt %, 1.0 wt %±0.75 wt %, or of about 1.0 wt %±0.25 wt %.

In an alternative embodiment, the non-organic anti-caking agent is included in an amount of about 0.25 wt % to 2 wt %, 0.50 wt % to 2.25 wt %, 0.75 wt % to 2.50 wt %, 0.90 wt % to 2.75 wt %, or 0.97 wt % to 3.0 wt %. In another embodiment, the non-organic anti-caking agent is included in an amount of about 0.60 wt % to 2.0 wt %, 0.70 wt % to 2.2 wt %, 0.80 wt % to 2.4 wt %, 0.90 wt % to 2.6 wt %, or 0.98 wt % to 2.80 wt %.

As used herein, the term “lubricant” means a substance that is included to prevent adhesion of a tablet to the press during the tableting procedure. High friction during tableting can cause a series of problems, including inadequate tablet quality (capping or even fragmentation of tablets during ejection, and vertical scratches on tablet edges) and may even stop production. Accordingly, lubricants are added to certain tablet formulations of the present invention including certain embodiments of the formulation described herein. Conventional tablet lubricants, such as stearic acid and its salts, are neither organic ingredients nor organic compliant materials. However, examples of organic lubricants include organic rice extracts, such as Nu-RICE® supplied by Ribus, Inc. of St. Louis, Mo. In an embodiment, the lubricant is included in an amount between about 0.5 wt % and about 3.0 wt % of the formulation. In an embodiment, the lubricant is included in an amount between about 0.5 wt % and about 1.0 wt % of the formulation. In an embodiment, the lubricant is included in an amount between about 1.0 wt % and about 1.5 wt % of the formulation. In an embodiment, the lubricant is included in an amount between about 1.5 wt % and about 2.0 wt % of the formulation. In an embodiment, the lubricant is included in an amount between about 2.0 wt % and about 2.5 wt % of the formulation. In an embodiment, the lubricant is included in an amount between about 2.5 wt % and about 3.0 wt % of the formulation. In an embodiment, the lubricant is included in an amount of about 1.97% of the formulation.

In an embodiment, the lubricant is included in an amount between about 1.0 wt % and about 3.0 wt % of the formulation. In an embodiment, the lubricant is included in an amount between about 1.25 wt % and about 3.0 wt % of the formulation. In an embodiment, the lubricant is included in an amount between about 1.50 wt % and about 3.0 wt % of the formulation. In an embodiment, the lubricant is included in an amount between about 1.75 wt % and about 3.0 wt % of the formulation. In an embodiment, the lubricant is included in an amount between about 1.95 wt % and about 3.0 wt % of the formulation. In an embodiment, the lubricant is included in an amount between about 1.0 wt % and about 2.75 wt % of the formulation. In an embodiment, the lubricant is included in an amount between about 1.0 wt % and about 2.5 wt % of the formulation. In an embodiment, the lubricant is included in an amount between about 1.0 wt % and about 2.25 wt % of the formulation. In an embodiment, the lubricant is included in an amount between about 1.0 wt % and about 2.0 wt % of the formulation.

In an embodiment, the lubricant is included in an amount of about 1.97 wt % of the formulation. In another embodiment, the lubricant is included in an amount of about 1.5 wt %, 1.6 wt %, 1.7 wt %, 1.8 wt %, 1.9 wt %, 2.0 wt %, 2.1 wt %, or 2.2 wt %.

In another embodiment, the lubricant is included in an amount of about 1.0 wt % to about 3.0 wt %, or from 1.25 wt % to 2.75 wt %, or 1.5 wt % to 2.5 wt %, or 1.75 wt % to 2.25 wt %, or from 1.95 wt % to 2.0 wt %.

In a further embodiment, the lubricant is included in an amount of about 1.97 wt %±1.0 wt %, 1.97 wt %±0.5 wt %, 1.97 wt %±0.75 wt %, or of about 1.97 wt %±0.25 wt %.

In an alternative embodiment, the lubricant is included in an amount of about 1.25 wt % to 2 wt %, 1.50 wt % to 2.25 wt %, 1.75 wt % to 2.50 wt %, 1.90 wt % to 1.75 wt %, or 1.95 wt % to 3.0 wt %. In another embodiment, the lubricant is included in an amount of about 1.60 wt % to 2.0 wt %, 1.70 wt % to 2.2 wt %, 1.80 wt % to 2.4 wt %, 1.90 wt % to 2.6 wt %, or 1.96 wt % to 2.80 wt %.

Examples of non-organic lubricants include stearic acid and magnesium stearate. In an embodiment, the non-organic lubricant is included in an amount between about 0.5 wt % and about 3.0 wt % of the formulation. In an embodiment, the non-organic lubricant is included in an amount between about 0.5 wt % and about 1.0 wt % of the formulation. In an embodiment, the non-organic lubricant is included in an amount between about 1.0 wt % and about 1.5 wt % of the formulation. In an embodiment, the non-organic lubricant is included in an amount between about 1.5 wt % and about 2.0 wt % of the formulation. In an embodiment, the non-organic lubricant is included in an amount between about 2.0 wt % and about 2.5 wt % of the formulation. In an embodiment, the non-organic lubricant is included in an amount between about 2.5 wt % and about 3.0 wt % of the formulation.

In an embodiment, the non-organic lubricant is included in an amount between about 1.0 wt % and about 3.0 wt % of the formulation. In an embodiment, the non-organic lubricant is included in an amount between about 1.25 wt % and about 3.0 wt % of the formulation. In an embodiment, the non-organic lubricant is included in an amount between about 1.50 wt % and about 3.0 wt % of the formulation. In an embodiment, the non-organic lubricant is included in an amount between about 1.75 wt % and about 3.0 wt % of the formulation. In an embodiment, the non-organic lubricant is included in an amount between about 1.95 wt % and about 3.0 wt % of the formulation. In an embodiment, the non-organic lubricant is included in an amount between about 1.0 wt % and about 2.75 wt % of the formulation. In an embodiment, the non-organic lubricant is included in an amount between about 1.0 wt % and about 2.5 wt % of the formulation. In an embodiment, the non-organic lubricant is included in an amount between about 1.0 wt % and about 2.2.5 wt % of the formulation. In an embodiment, the non-organic lubricant is included in an amount between about 1.0 wt % and about 2.0 wt % of the formulation.

In an embodiment, the non-organic lubricant is included in an amount of about 1.97 wt % of the formulation. In another embodiment, the non-organic lubricant is included in an amount of about 1.5 wt %, 1.6 wt %, 1.7 wt %, 1.8 wt %, 1.9 wt %, 2.0 wt %, 2.1 wt %, or 2.2 wt %.

In another embodiment, the n-organic lubricant is included in an amount of about 1.0 wt % to about 3.0 wt %, or from 1.25 wt % to 2.75 wt %, or 1.5 wt % to 2.5 wt %, or 1.75 wt % to 2.25 wt %, or from 1.95 wt % to 2.0 wt %.

In a further embodiment, the non-organic lubricant is included in an amount of about 1.97 wt %±1.0 wt %, 1.97 wt %±0.5 wt %, 1.97 wt %±0.75 wt %, or of about 1.97 wt %±0.25 wt %.

In an alternative embodiment, the non-organic lubricant is included in an amount of about 1.25 wt % to 2 wt %, 1.50 wt % to 2.25 wt %, 1.75 wt % to 2.50 wt %, 1.90 wt % to 1.75 wt %, or 1.95 wt % to 3.0 wt %. In another embodiment, the non-organic lubricant is included in an amount of about 1.60 wt % to 2.0 wt %, 1.70 wt % to 2.2 wt %, 1.80 wt % to 2.4 wt %, 1.90 wt % to 2.6 wt %, or 1.96 wt % to 2.80 wt %.

In another embodiment of the invention, the organic dietary supplement may include a disintegrant or a dispersant. A disintegrant refers to an agent used in pharmaceutical preparation of tablets, which causes them to disintegrate and release their medicinal substances on contact with moisture. In an embodiment, the disintegrant may be water soluble to support the disintegration of a tablet in the stomach. Examples of organic disintegrants may be those selected from appropriate organic starches, such as organic pre-gelatinized potato starch. In an embodiment, the disintegrant is included in an amount between about 1.0 wt % and about 3.0 wt % of the formulation. In an embodiment, the disintegrant is included in an amount between about 0.5 wt % and about 1.0 wt % of the formulation. In an embodiment, the disintegrant is included in an amount between about 1.0 wt % and about 1.5 wt % of the formulation. In an embodiment, the disintegrant is included in an amount between about 1.5 wt % and about 2.0 wt % of the formulation. In an embodiment, the disintegrant is included in an amount between about 2.0 wt % and about 2.5 wt % of the formulation. In an embodiment, the disintegrant is included in an amount between about 2.5 wt % and about 3.0 wt % of the formulation. In an embodiment, the disintegrant is included in an amount of about 1.97% of the formulation.

In an embodiment, the disintegrant is included in an amount between about 1.0 wt % and about 3.0 wt % of the formulation. In an embodiment, the disintegrant is included in an amount between about 1.25 wt % and about 3.0 wt % of the formulation. In an embodiment, the disintegrant is included in an amount between about 1.50 wt % and about 3.0 wt % of the formulation. In an embodiment, the disintegrant is included in an amount between about 1.75 wt % and about 3.0 wt % of the formulation. In an embodiment, the disintegrant is included in an amount between about 1.95 wt % and about 3.0 wt % of the formulation. In an embodiment, the disintegrant is included in an amount between about 1.0 wt % and about 2.75 wt % of the formulation. In an embodiment, the disintegrant is included in an amount between about 1.0 wt % and about 2.5 wt % of the formulation. In an embodiment, the disintegrant is included in an amount between about 1.0 wt % and about 2.25 wt % of the formulation. In an embodiment, the disintegrant is included in an amount between about 1.0 wt % and about 2.0 wt % of the formulation.

In an embodiment, the disintegrant is included in an amount of about 1.97 wt % of the formulation. In another embodiment, the disintegrant is included in an amount of about 1.5 wt %, 1.6 wt %, 1.7 wt %, 1.8 wt %, 1.9 wt %, 2.0 wt %, 2.1 wt %, or 2.2 wt %.

In another embodiment, the disintegrant is included in an amount of about 1.0 wt % to about 3.0 wt %, or from 1.25 wt % to 2.75 wt %, or 1.5 wt % to 2.5 wt %, or 1.75 wt % to 2.25 wt %, or from 1.95 wt % to 2.0 wt %.

In a further embodiment, the disintegrant is included in an amount of about 1.97 wt % 1.0 wt %, 1.97 wt %±0.5 wt %, 1.97 wt %±0.75 wt %, or of about 1.97 wt %±0.25 wt %.

In an alternative embodiment, the disintegrant is included in an amount of about 1.25 wt % to 2 wt %, 1.50 wt % to 2.25 wt %, 1.75 wt % to 2.50 wt %, 1.90 wt % to 1.75 wt %, or 1.95 wt % to 3.0 wt %. In another embodiment, the disintegrant is included in an amount of about 1.60 wt % to 2.0 wt %, 1.70 wt % to 2.2 wt %, 1.80 wt % to 2.4 wt %, 1.90 wt % to 2.6 wt %, or 1.96 wt % to 2.80 wt %.

Examples of non-organic disintegrants may include croscarmellose sodium. In an embodiment, the non-organic disintegrant is included in an amount between about 1.0 wt % and about 3.0 wt % of the formulation. In an embodiment, the non-organic disintegrant is included in an amount between about 0.5 wt % and about 1.0 wt % of the formulation. In an embodiment, the non-organic disintegrant is included in an amount between about 1.0 wt % and about 1.5 wt % of the formulation. In an embodiment, the non-organic disintegrant is included in an amount between about 1.5 wt % and about 2.0 wt % of the formulation. In an embodiment, the non-organic disintegrant is included in an amount between about 2.0 wt % and about 2.5 wt % of the formulation. In an embodiment, the non-organic disintegrant is included in an amount between about 2.5 wt % and about 3.0 wt % of the formulation.

In an embodiment, the non-organic disintegrant is included in an amount between about 1.0 wt % and about 3.0 wt % of the formulation. In an embodiment, the non-organic disintegrant is included in an amount between about 1.25 wt % and about 3.0 wt % of the formulation. In an embodiment, the non-organic disintegrant is included in an amount between about 1.50 wt % and about 3.0 wt % of the formulation. In an embodiment, the non-organic disintegrant is included in an amount between about 1.75 wt % and about 3.0 wt % of the formulation. In an embodiment, the non-organic disintegrant is included in an amount between about 1.95 wt % and about 3.0 wt % of the formulation. In an embodiment, the non-organic disintegrant is included in an amount between about 1.0 wt % and about 2.75 wt % of the formulation. In an embodiment, the non-organic disintegrant is included in an amount between about 1.0 wt % and about 2.5 wt % of the formulation. In an embodiment, the non-organic disintegrant is included in an amount between about 1.0 wt % and about 2.25 wt % of the formulation. In an embodiment, the non-organic disintegrant is included in an amount between about 1.0 wt % and about 2.0 wt % of the formulation.

In an embodiment, the non-organic disintegrant is included in an amount of about 1.97 wt % of the formulation. In another embodiment, the non-organic disintegrant is included in an amount of about 1.5 wt %, 1.6 wt %, 1.7 wt %, 1.8 wt %, 1.9 wt %, 2.0 wt %, 2.1 wt %, or 2.2 wt %.

In another embodiment, the non-organic disintegrant is included in an amount of about 1.0 wt % to about 3.0 wt %, or from 1.25 wt % to 2.75 wt %, or 1.5 wt % to 2.5 wt %, or 1.75 wt % to 2.25 wt %, or from 1.95 wt % to 2.0 wt %.

In a further embodiment, the non-organic disintegrant is included in an amount of about 1.97 wt %±1.0 wt %, 1.97 wt %±0.5 wt %, 1.97 wt %±0.75 wt %, or of about 1.97 wt % 0.25 wt %.

In an alternative embodiment, the non-organic disintegrant is included in an amount of about 1.25 wt % to 2 wt %, 1.50 wt % to 2.25 wt %, 1.75 wt % to 2.50 wt %, 1.90 wt % to 1.75 wt %, or 1.95 wt % to 3.0 wt %. In another embodiment, the non-organic disintegrant is included in an amount of about 1.60 wt % to 2.0 wt %, 1.70 wt % to 2.2 wt %, 1.80 wt % to 2.4 wt %, 1.90 wt % to 2.6 wt %, or 1.96 wt % to 2.80 wt %.

In another embodiment, the organic dietary supplement may include a glidant. A glidant can be used to improve powder flow properties prior to and during tableting and to reduce caking. Examples of organic glidants include those based on tapioca, such as TapiOK® organic tapioca dextrose supplied by Ciranda, Inc. or Hudson, Wis. In an embodiment, the glidant is included in an amount between about 40.0 wt % and about 50.0 wt % of the formulation. In an embodiment, the glidant is included in an amount between about 40.0 wt % and about 40.5 wt % of the formulation. In an embodiment, the glidant is included in an amount between about 45.5 wt % and about 50.0 wt % of the formulation. In an embodiment, the glidant is included in an amount of about 45.79% of the formulation.

In an embodiment, the glidant is included in an amount between about 42.0 wt % and about 50.0 wt % of the formulation. In an embodiment, the glidant is included in an amount between about 42.5 wt % and about 50.0 wt % of the formulation. In an embodiment, the glidant is included in an amount between about 43.0 wt % and about 50.0 wt % of the formulation. In an embodiment, the glidant is included in an amount between about 43.5 wt % and about 50.0 wt % of the formulation. In an embodiment, the glidant is included in an amount between about 44.0 wt % and about 50.0 wt % of the formulation. In an embodiment, the glidant is included in an amount between about 44.5 wt % and about 50.0 wt % of the formulation. In an embodiment, the glidant is included in an amount between about 45.0 wt % and about 50.0 wt % of the formulation. In an embodiment, the glidant is included in an amount between about 42.0 wt % and about 47.5 wt % of the formulation. In an embodiment, the glidant is included in an amount between about 42.5 wt % and about 47.5 wt % of the formulation. In an embodiment, the glidant is included in an amount between about 44.0 wt % and about 47.5 wt % of the formulation.

In an embodiment, the glidant is included in an amount of about 45.79 wt % of the formulation. In another embodiment, the glidant is included in an amount of about 44.0 wt %, 44.25 wt %, 44.5 wt %, 44.75 wt %, 45.0 wt %, 45.25 wt %, 45.5 wt %, 45.75 wt %, 46.0 wt %, or 46.25 wt %.

In another embodiment, the glidant is included in an amount of about 42.0 wt % to about 48.0 wt %, or from 43.0 wt % to 47.0 wt %, or 44.0 wt % to 46.0 wt %, or 45.0 wt % to 45.9 wt %, or from 45.5 wt % to 45.8 wt %.

In a further embodiment, the glidant is included in an amount of about 45.79 wt %±1.0 wt %, 45.79 wt %±0.5 wt %, 45.79 wt %±0.75 wt %, or of about 45.79 wt %±0.25 wt %.

In an alternative embodiment, the glidant is included in an amount of about 42 wt % to 44 wt %, 42 wt % to 45 wt %, 44 wt % to 46 wt %, 45 wt % to 47 wt %, or 46 wt % to 48 wt %. In another embodiment, the glidant is included in an amount of about 43.5 wt % to 48 wt %, 43.5 wt % to 47 wt %, 43.5 wt % to 46 wt %, 43.5 wt % to 45 wt %, or 43.5 wt % to 44 wt %.

Examples of non-organic glidants include coarse DCP, Cantab dextrose, Talc, and silicon dioxide. In an embodiment, the non-organic glidant is included in an amount between about 0.50 wt % and about 2.00 wt % of the formulation. In an embodiment, the non-organic glidant is included in an amount between about 0.5 wt % and about 1.0 wt % of the formulation. In an embodiment, the non-organic glidant is included in an amount between about 1.0 wt % and about 1.5 wt % of the formulation. In an embodiment, the non-organic glidant is included in an amount between about 1.5 wt % and about 2.0 wt % of the formulation. In an embodiment, the non-organic glidant is included in an amount between about 0.50 wt % and 30.00 wt % of the formulation.

In an embodiment, the non-organic glidant is included in an amount between about 42.0 wt % and about 50.0 wt % of the formulation. In an embodiment, the non-organic glidant is included in an amount between about 42.5 wt % and about 50.0 wt % of the formulation. In an embodiment, the non-organic glidant is included in an amount between about 43.0 wt % and about 50.0 wt % of the formulation. In an embodiment, the non-organic glidant is included in an amount between about 43.5 wt % and about 50.0 wt % of the formulation. In an embodiment, the non-organic glidant is included in an amount between about 44.0 wt % and about 50.0 wt % of the formulation. In an embodiment, the non-organic glidant is included in an amount between about 44.5 wt % and about 50.0 wt % of the formulation. In an embodiment, the non-organic glidant is included in an amount between about 45.0 wt % and about 50.0 wt % of the formulation. In an embodiment, the non-organic glidant is included in an amount between about 42.0 wt % and about 47.5 wt % of the formulation. In an embodiment, the non-organic glidant is included in an amount between about 42.5 wt % and about 47.5 wt % of non-organic glidant formulation. In an embodiment, the non-organic glidant is included in an amount between about 44.0 wt % and about 47.5 wt % of the formulation.

In an embodiment, the non-organic glidant is included in an amount of about 45.79 wt % of the formulation. In another embodiment, the non-organic glidant is included in an amount of about 44.0 wt %, 44.25 wt %, 44.5 wt %, 44.75 wt %, 45.0 wt %, 45.25 wt %, 45.5 wt %, 45.75 wt %, 46.0 wt %, or 46.25 wt %.

In another embodiment, the non-organic glidant is included in an amount of about 42.0 wt % to about 48.0 wt %, or from 43.0 wt % to 47.0 wt %, or 44.0 wt % to 46.0 wt %, or 45.0 wt % to 45.9 wt %, or from 45.5 wt % to 45.8 wt %.

In a further embodiment, the non-organic glidant is included in an amount of about 45.79 wt %±1.0 wt %, 45.79 wt %±0.5 wt %, 45.79 wt %±0.75 wt %, or of about 45.79 wt %±0.25 wt %.

In an alternative embodiment, the non-organic glidant is included in an amount of about 42 wt % to 44 wt %, 42 wt % to 45 wt %, 44 wt % to 46 wt %, 45 wt % to 47 wt %, or 46 wt % to 48 wt %. In another embodiment, the non-organic glidant is included in an amount of about 43.5 wt % to 48 wt %, 43.5 wt % to 47 wt %, 43.5 wt % to 46 wt %, 43.5 wt % to 45 wt %, or 43.5 wt % to 44 wt %.

In an embodiment, sweeteners may be added to enhance the flavor of the organic dietary vitamins. Sweeteners that can also be used in the taste-masking coating of certain embodiments of the matrix dosage forms include glucose (corn syrup), dextrose, Dextrose Cantab®, invert sugar, fructose, and mixtures thereof (when not used as a carrier); saccharin and its various salts, such as sodium salt; dipeptide sweeteners such as aspartame; dihydrochalcone compounds, glycyrrhizin; Stevia Rebaudiana (Stevioside); Organic Stevia Blend Sweetener, chloro derivatives or sucrose such as sucralose; and sugar alcohols such as sorbitol, mannitol, xylitol, and the like. Also contemplated are hydrogenated starch hydrolysates and the synthetic sweeteners such as 3,6-dihydro-6-methyl-1-1-1,2,3-oxathiazin-4-1-2,2-dioxide, particularly the potassium salt (acesulfame-K), and sodium and calcium salts thereof. The sweeteners can be used alone or in any combination thereof. In an embodiment of the present invention, sweeteners are not added to the organic dietary supplement.

In an embodiment, the dietary supplement may be coated. Coatings may provide a variety of functions. In some embodiments, coatings may be used, for example, to achieve delayed release, resistance to acid, targeted release in the lower GI tract, avoidance of bad taste in mouth. In some embodiments, coatings may be used to protect the organic dietary supplement from light and provide for better mechanical resistance. Of course it should be appreciated that a coating may serve other functions as well and a person skilled in the art knows the purpose of tablet coating. In one embodiment, the organic coating is included in an amount between about 0.6 wt % and 1.0 wt % of the formulation. In an embodiment, the organic coating is developed by Colorcon, Inc. called Opadry Nutrapure™. In an embodiment of the present invention, the organic dietary supplement is not coated.

Additional additives and their levels, and selection of a primary coating material or materials will depend on the following properties: pH levels at target site, desirability to make tablet pH dependent or pH independent, solubility in alcohol, resistance to dissolution and disintegration in the stomach; impermeability to gastric fluids and drug/carrier/enzyme while in the stomach; ability to dissolve or disintegrate rapidly at the target intestine site; physical and chemical stability during storage; non-toxicity; easy application as a coating (substrate friendly); and economical practicality.

### III. Methods of Manufacturing an Organic Dietary Supplement

The current invention additionally encompasses a method of manufacturing an organic dietary supplement, comprising adding an aqueous granulating solution to an organic supplement formulation, wherein the aqueous granulating solution comprises about 18% organic gum arabic. The organic dietary supplement prepared in accordance with the present invention exhibits acceptable physical characteristics including increased compressibility and increased flowability. In an embodiment, the organic dietary supplements disclosed herein have compressibility of about 27.8 kp, which is approximately a 45% improvement when compared to traditional methods. Additionally, the organic dietary supplements disclosed herein have flowability of about 30.6 C or 31 C, which is approximately a 13% improvement when compared to traditional methods.

It should be appreciated to one skilled in the art that the current invention additionally encompasses a method of manufacturing a non-organic dietary supplement, comprising adding an aqueous granulating solution to an organic supplement formulation, wherein the aqueous granulating solution comprises about 7% Hydroxypropylcellulose (HPC). The non-organic dietary supplement prepared in accordance with the present invention exhibit acceptable physical characteristics including increased compressibility and increased flowability. In an embodiment, the non-organic dietary supplements, e.g., immune boosting tablet, disclosed herein have a compressibility of about 23.7 kp, which is approximately a 122% improvement when compared to traditional methods. In another embodiment, the non-organic dietary supplements, e.g., testosterone boosting tablet, disclosed herein have a compressibility of about 38.3 kp, which is a significant improvement over other tablets of comparable size and shape.

In accordance with one embodiment, the dietary supplements of the present invention, including organic and non-organic ones, can be manufactured by either wet, partially wet or dry granulation, blending the resulting granulate with excipients, and then compressing the composition into tablets.

In one embodiment, granulation is used to prepare granules comprising the organic dietary supplement. In accordance with one embodiment of the invention, a granulating liquid or aqueous granulating solution is used in the granulation process. In one embodiment, the granulating liquid is an aqueous liquid, or more specifically, a mixture of both gum arabic or HPC, and reverse osmosis, de-ionized, distilled, and/or purified, water. The amount of the granulating liquid used may depend on many factors, for example, the type of the granulating liquid, the amount of the granulating liquid used, the type of excipient used, the nature of the active ingredient, and the active ingredient loading.

In one embodiment, the method of the present invention includes making an aqueous granulating solution comprising adding organic gum arabic to a formulation during the manufacturing process. In one embodiment, the concentration of organic gum arabic in the aqueous granulating solution is from about 14% to about 20% by weight of the solution. In another embodiment, the concentration of organic gum arabic in the aqueous granulating solution is about 14% by weight of the solution. In another embodiment, the concentration of organic gum arabic in the aqueous granulating solution is about 15% by weight of the solution. In another embodiment, the concentration of organic gum arabic in the aqueous granulating solution is about 16% by weight of the solution. In another embodiment, the concentration of organic gum arabic in the aqueous granulating solution is about 17% by weight of the solution. In another embodiment, the concentration of organic gum arabic in the aqueous granulating solution is about 18% by weight of the solution. As used herein, the term “about” or “approximately” refers to a variation of 10% from the indicated values, or in case of a range of values, means a 10% variation from both the lower and upper limits of such ranges. For instance, “about 18%” refers to a range of between 16.2% and 19.8%.

In an embodiment, the organic gum arabic is included in an amount between about 14.0 wt % and about 20.0 wt % of the solution. In an embodiment, the organic gum arabic is included in an amount between about 15.0 wt % and about 20.0 wt % of the solution. In an embodiment, the organic gum arabic is included in an amount between about 16.0 wt % and about 20.0 wt % of the solution. In an embodiment, the organic gum arabic is included in an amount between about 17.0 wt % and about 20.0 wt % of the solution. In an embodiment, the organic gum arabic is included in an amount between about 18.0 wt % and about 20.0 wt % of the solution. In an embodiment, the organic gum arabic is included in an amount between about 19.0 wt % and about 20.0 wt % of the solution. In an embodiment, the organic gum arabic is included in an amount between about 14.0 wt % and about 19.0 wt % of the solution. In an embodiment, the organic gum arabic is included in an amount between about 14.0 wt % and about 18.0 wt % of the solution. In an embodiment, the organic gum arabic is included in an amount between about 14.0 wt % and about 17.0 wt % of the solution. In an embodiment, the organic gum arabic is included in an amount between about 16.0 wt % and about 19.0 wt % of the solution.

In an embodiment, the organic gum arabic is included in an amount of about 18 wt % of the solution. In another embodiment, the organic gum arabic is included in an amount of about 14.0 wt %, 14.50 wt %, 15.0 wt %, 15.5 wt %, 16.0 wt %, 16.5 wt %, 17.0 wt %, 17.5 wt %, 18.50 wt %, or 19.0 wt %.

In another embodiment, the organic gum arabic is included in an amount of about 14.0 wt % to about 20.0 wt %, or from 15.0 wt % to 19.0 wt %, or 16.0 wt % to 18.75 wt %, or 17.0 wt % to 18.5 wt %, or from 17.5 wt % to 18.25 wt %.

In a further embodiment, the organic gum arabic is included in an amount of about 18.0 wt %±1.0 wt %, 18.0 wt %±0.5 wt %, 18.0 wt %±0.75 wt %, or of about 18.0 wt % 0.25 wt %.

In an alternative embodiment, the organic gum arabic is included in an amount of about 14 wt % to 20 wt %, 14 wt % to 18 wt %, 15 wt % to 19 wt %, 15 wt % to 17 wt %, 16 wt % to 20 wt % or 16 wt % to 18 wt %. In another embodiment, the organic gum arabic is included in an amount of about 14.5 wt % to 18.5 wt %, 15.5 wt % to 19.5 wt %, 16.5 wt % to 17.5 wt %, 17.5 wt % to 18.5 wt %, or 17.75 wt % to 18.25 wt %.

In accordance with another embodiment, the method of the present invention includes making an aqueous granulating solution comprising adding HPC to a formulation during the manufacturing process. In one embodiment, the concentration of HPC in the aqueous granulating solution is from about 4% to about 16% by weight of the solution. In another embodiment, the concentration of HPC in the aqueous granulating solution is from about 4% to about 6% by weight of the solution. In another embodiment, the concentration of HPC in the aqueous granulating solution is from about 6% to about 8% by weight of the solution. In another embodiment, the concentration of HPC in the aqueous granulating solution is from about 8% to about 10% by weight of the solution. In another embodiment, the concentration of HPC in the aqueous granulating solution is from about 10% to about 12% by weight of the solution. In another embodiment, the concentration of HPC in the aqueous granulating solution is from about 12% to about 14% by weight of the solution. In another embodiment, the concentration of HPC in the aqueous granulating solution is from about 14% to about 16% by weight of the solution. In another embodiment, the concentration of HPC in the aqueous granulating solution is about 7% by weight of the solution. As used herein, the term “about” or “approximately” refers to a variation of 10% from the indicated values, or in case of a range of values, means a 10% variation from both the lower and upper limits of such ranges. For instance, “about 7%” refers to a range of between 6.3% and 7.7%.

In an embodiment, the HPC is included in an amount between about 4.0 wt % and about 16.0 wt % of the solution. In an embodiment, the HPC is included in an amount between about 5.0 wt % and about 16.0 wt % of the solution. In an embodiment, the HPC is included in an amount between about 6.0 wt % and about 16.0 wt % of the solution. In an embodiment, the HPC is included in an amount between about 7.0 wt % and about 16.0 wt % of the solution. In an embodiment, the HPC is included in an amount between about 8.0 wt % and about 16.0 wt % of the solution. In an embodiment, the HPC is included in an amount between about 9.0 wt % and about 16.0 wt % of the solution. In an embodiment, the HPC is included in an amount between about 4.0 wt % and about 14.0 wt % of the solution. In an embodiment, the HPC is included in an amount between about 4.0 wt % and about 12.0 wt % of the solution. In an embodiment, the HPC is included in an amount between about 4.0 wt % and about 10.0 wt % of the solution. In an embodiment, the HPC is included in an amount between about 4.0 wt % and about 9.0 wt % of the solution.

In an embodiment, the HPC is included in an amount of about 7 wt % of the solution. In another embodiment, the HPC is included in an amount of about 4.0 wt %, 4.50 wt %, 5.0 wt %, 5.5 wt %, 6.0 wt %, 6.5 wt %, 7.0 wt %, 7.5 wt %, 8.50 wt %, or 9.0 wt %.

In another embodiment, the HPC is included in an amount of about 4.0 wt % to about 16.0 wt %, or from 5.0 wt % to 15.0 wt %, or 6.0 wt % to 14.0 wt %, or 7.0 wt % to 13.0 wt %, or from 7.5 wt % to 12.0 wt %.

In a further embodiment, the HPC is included in an amount of about 7.0 wt % 1.0 wt %, 7.0 wt %±0.5 wt %, 7.0 wt %±0.75 wt %, or of about 7.0 wt %±0.25 wt %.

In an alternative embodiment, the HPC is included in an amount of about 4 wt % to 16 wt %, 4 wt % to 14 wt %, 5 wt % to 15 wt %, 5 wt % to 13 wt %, 6 wt % to 12 wt % or 6 wt % to 10 wt %. In another embodiment, the HPC is included in an amount of about 4.5 wt % to 15.5 wt %, 5.5 wt % to 14.5 wt %, 6.5 wt % to 13.5 wt %, 7.5 wt % to 12.5 wt %, or 8.5 wt % to 11.5 wt %.

In accordance with an embodiment of the present invention, the aqueous granulating solution further comprises reverse osmosis/de-ionized (RODI) water. In one embodiment, the concentration of RODI water in the aqueous granulating solution is from about 70% to about 95% by weight of the solution. In another embodiment, the concentration of RODI water in the aqueous granulating solution is from about 70% to about 75% by weight of the solution. In another embodiment, the concentration of RODI water in the aqueous granulating solution is from about 75% to about 80% by weight of the solution. In another embodiment, the concentration of RODI water in the aqueous granulating solution is from about 80% to about 85% by weight of the solution. In another embodiment, the concentration of RODI water in the aqueous granulating solution is from about 85% to about 90% by weight of the solution. In another embodiment, the concentration of RODI water in the aqueous granulating solution is from about 90% to about 95% by weight of the solution. In another embodiment, the concentration of RODI water in the aqueous granulating solution is about 82% by weight of the solution. In another embodiment, the concentration of RODI water in the aqueous granulating solution is about 93% by weight of the solution.

In an embodiment, the RODI water is included in an amount between about 60.0 wt % and about 95.0 wt % of the solution. In an embodiment, the RODI water is included in an amount between about 65.0 wt % and about 95.0 wt % of the solution. In an embodiment, the RODI water is included in an amount between about 70.0 wt % and about 95.0 wt % of the solution. In an embodiment, the RODI water is included in an amount between about 75.0 wt % and about 95.0 wt % of the solution. In an embodiment, the RODI water is included in an amount between about 80.0 wt % and about 95.0 wt % of the solution. In an embodiment, the RODI water is included in an amount between about 85.0 wt % and about 95.0 wt % of the solution. In an embodiment, the RODI water is included in an amount between about 90.0 wt % and about 95.0 wt % of the solution. In an embodiment, the RODI water is included in an amount between about 70.0 wt % and about 90.0 wt % of the solution. In an embodiment, the RODI water is included in an amount between about 70.0 wt % and about 88.0 wt % of the solution. In an embodiment, the RODI water is included in an amount between about 70.0 wt % and about 86.0 wt % of the solution. In an embodiment, the RODI water is included in an amount between about 70.0 wt % and about 84.0 wt % of the solution.

In an embodiment, the RODI water is included in an amount of about 82 wt % of the solution. In another embodiment, the RODI water is included in an amount of about 70.0 wt %, 72.0 wt %, 74.0 wt %, 76.0 wt %, 78.0 wt %, 80.0 wt %, 81.0 wt %, 83.0 wt %, 85.0 wt %, or 87.0 wt %.

In another embodiment, the RODI water is included in an amount of about 70.0 wt % to about 95 wt %, or from 75.0 wt % to 90.0 wt %, or 80.0 wt % to 85.0 wt %, or 81.0 wt % to 83.0 wt %.

In a further embodiment, the RODI water is included in an amount of about 82.0 wt %±1.0 wt %, 82.0 wt %±0.5 wt %, 82.0 wt %±0.75 wt %, or of about 82.0 wt % 0.25 wt %.

In an alternative embodiment, the RODI water is included in an amount of about 70.0 wt % to 90.0 wt %, 70.0 wt % to 88.0 wt %, 75.0 wt % to 86.0 wt %, 75.0 wt % to 84.0 wt %, 75.0 wt % to 82.0 wt % or 80.0 wt % to 82.0 wt %. In another embodiment, the RODI water is included in an amount of about 65.0 wt % to 95.5 wt %, 65.5 wt % to 85.5 wt %, or 65.5 wt % to 75.5 wt %.

In accordance with an embodiment of the present invention, the aqueous granulating solution comprises less than or equal to about 2.0% by weight of the formulation. In an embodiment, the aqueous granulating solution comprises less than or equal to about 1.9%, 1.8%, 1.7%, 1.6%, 1.5%, 1.4%, 1.3%, 1.2%, 1.1%, 1.0%, 0.9%, 0.8%, 0.7%, 0.6%, 0.5%, 0.4%, 0.3%, 0.2%, or 0.1% by weight of the formulation. In one embodiment, the aqueous granulating solution comprises about 0.75% by weight of the formulation. By keeping the amount of aqueous granulating solution at or less than 2.0% by weight of the formulation, the invention of the present disclosure is able to reduce, minimize and/or even eliminate the need to dry the granulate during processing. This not only reduces the time associated with manufacturing the organic dietary supplements, but it also reduces the costs to the clients.

In one embodiment, the active ingredients and suitable excipients are mixed with the aqueous granulating liquid for a sufficiently long period to facilitate good distribution of all starting materials and good content uniformity. Granulation is generally performed at temperatures between about 20° C. to about 35° C., or more specifically, at room temperature (about 25° C.). It should be appreciated that the overall time to perform the granulation process may depend on a variety of factors, including but not limited to, the solvents used, batch size, instruments used, etc.

Any equipment may be used to contact the aqueous granulating liquid with the active ingredients and the excipients as long as uniform distribution of the granulating liquid is achieved. For example, small-scale production can be achieved by mixing and wetting the ingredients and the excipients in mortars or stainless steel bowls, while for larger quantities, V-blenders with intensifier bars, planetary mixers, rotary granulators, high shear granulators, and fluid-bed granulation equipment may be used. In one embodiment, the granulator is a high shear granulator.

Mixing can be carried out for a sufficient time to produce homogeneous mixtures or blends. Mixing may be accomplished by blending, stiffing, shaking, tumbling, rolling, or by any other method to achieve a homogeneous blend. In some embodiments, the components to be mixed are combined under low shear conditions in a suitable apparatus, such as a V-blender, tote blender, double cone blender or any other apparatus capable of functioning under low shear conditions.

In one embodiment, a method of making an organic dietary supplement comprises blending in a 75 cubic foot v-blender for 2 minutes (I-bar off) active ingredients with acceptable excipients, such as Orgen HIM Plus®, vitamin K1 renatured 207M, vitamin B12 renatured, vitamin D3, vitamin K2, organic moringa leaf extract, organic wrightia herb extract, organic lantana herb extract, organic curry leaves extract, organic veggie blend, organic fruit blend, TapiOK® and Nu-RICE® (sifted through a #12 screen). The resulting mixture would then be dumped into barrels, sifted through a #12 screen and added to a v-blender for 5 minutes (I-bar off). After the 5 minutes of mixing, the mixture would continue tumbling while an aqueous granulating liquid (18% gum arabic/82% water solution) is added to the mix with the liquid addition bar on at 900 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing. Once finished, compressed air would be used to flush the system for 10 seconds with the liquid addition bar still on. Next, the liquid addition bar would be turned off and the mixture would continue mixing for another 2 minutes and 30 seconds. Immediately after mixing, the blend would be dumped and sifted through a #12 screen and then added back to the blender. A barrel of material would be dumped from the blender and the organic pre-gelatinized potato starch would be weighed out. This material would then be sifted through a #20 screen two (2) times and then added to the blender. Any hard granules that would not easily pass through the #20 screen would be added back to the blender. The blender would then be jogged for three (3) rotations, a barrel of material from the blender would be dumped, and the Nu-Flow would be weighed out. The remaining material would be sifted through a #20 screen two (2) times and then added to the blender. Any hard granules that will not easily pass through the #20 screen would be added back to the blender. The mixture would then be mixed in the v-blender for 3 minutes and 45 seconds (bar off). Immediately after mixing, the blend would be dumped and sifted through a #12 screen. If possible, push overs would be sifted through the screen by hand. Material that cannot be pushed through the screen by hand is to be milled until 100% of the blend passes through the #12 screen. The resulting batch would range between 1007 kg to 1230 kg.

In another embodiment of the present invention, a method of making an organic dietary supplement comprises blending in a 30 cubic foot v-blender for 1 minute 30 seconds (I-bar off) active ingredients with acceptable excipients, such as Orgen HIM Plus®, vitamin K1 renatured 207M, vitamin B12 renatured, vitamin D3, vitamin K2, organic moringa leaf extract, organic wrightia herb extract, organic lantana herb extract, organic curry leaves extract, organic veggie blend, organic fruit blend, TapiOK® and Nu-RICE® (sifted through a #12 screen). The resulting mixture would then be dumped into barrels, sifted through a #12 screen and added to a v-blender for 4 minutes (I-bar off). After the 4 minutes of mixing, the mixture would continue tumbling while an aqueous granulating liquid (18% gum arabic/82% water solution) is added to the mix with the liquid addition bar on at 700 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing. Once finished, compressed air would be used to flush the system for 10 seconds with the liquid addition bar still on. Next, the liquid addition bar would be turned off and the mixture would continue mixing for another 2 minutes. Immediately after mixing, the blend would be dumped and sifted through a #12 screen and then added back to the blender. A barrel of material would be dumped from the blender and the organic pre-gelatinized potato starch would be weighed out. This material would then be sifted through a #20 screen two (2) times and then added to the blender. Any hard granules that would not easily pass through the #20 screen would be added back to the blender. The blender would then be jogged for three (3) rotations, a barrel of material from the blender would be dumped, and the Nu-Flow would be weighed out. The remaining material would be sifted through a #20 screen two (2) times and then added to the blender. Any hard granules that will not easily pass through the #20 screen would be added back to the blender. The mixture would then be mixed in the v-blender for 3 minutes (bar off). Immediately after mixing, the blend would be dumped and sifted through a #12 screen. If possible, push overs would be sifted through the screen by hand. Material that cannot be pushed through the screen by hand is to be milled until 100% of the blend passes through the #12 screen. The resulting batch would range between 403 kg to 492 kg.

In another embodiment of the present invention, a method of making an organic dietary supplement comprises blending in a 5 cubic foot v-blender for 1 minute (I-bar off) active ingredients with acceptable excipients, such as Orgen HIM Plus®, vitamin K1 renatured 207M, vitamin B12 renatured, vitamin D3, vitamin K2, organic moringa leaf extract, organic wrightia herb extract, organic lantana herb extract, organic curry leaves extract, organic veggie blend, organic fruit blend, TapiOK® and Nu-RICE® (sifted through a #12 screen. The resulting mixture would then be dumped into barrels, sifted through a #12 screen and added to a v-blender for 3 minutes (I-bar off). After the 3 minutes of mixing, the mixture would continue tumbling while an aqueous granulating liquid (18% gum arabic/82% water solution) is added to the mix and the aqueous granulating solution with the liquid addition bar on at 225 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing is added. Once finished, compressed air would be used to flush the system for 10 seconds with the liquid addition bar still on. Next, the liquid addition bar would be turned off and the mixture would continue mixing for another 1 minute 30 seconds. Immediately after mixing, the blend would be dumped and sifted through a #12 screen and then added back to the blender. A barrel of material would be dumped from the blender and the organic pre-gelatinized potato starch would be weighed out. This material would then be sifted through a #20 screen two (2) times and then added to the blender. Any hard granules that would not easily pass through the #20 screen would be added back to the blender. The blender would then be jogged for three (3) rotations, a barrel of material from the blender would be dumped, and the Nu-Flow would be weighed out. The remaining material would be sifted through a #20 screen two (2) times and then added to the blender. Any hard granules that will not easily pass through the #20 screen would be added back to the blender. The mixture would then be mixed in the v-blender for 2 minutes 30 seconds (bar off). Immediately after mixing, the blend would be dumped and sifted through a #12 screen. If possible, push overs would be sifted through the screen by hand. Material that cannot be pushed through the screen by hand is to be milled until 100% of the blend passes through the #12 screen. The resulting batch would range between 68 kg to 82 kg.

In one embodiment, a method of making an organic dietary supplement comprises blending in a 75 cubic foot v-blender for 2 minutes (I-bar off) active ingredients with acceptable excipients, such as Orgen HIM Plus®, Organic Sea Kelp, vitamin K1 renatured, vitamin B12 renatured 207M, vitamin D3, vitamin K2, organic moringa leaf extract, organic wrightia herb extract, organic lantana herb extract, organic pomegranate juice pwd, organic tomato powder, organic turmeric powder, organic pumpkin powder, organic veggie blend, organic fruit blend, and Nu-RICE® (sifted through a #12 screen). The resulting mixture would then be dumped into barrels, sifted through a #12 screen and added to a v-blender for 5 minutes (I-bar off). After the 5 minutes of mixing, the mixture would continue tumbling while an aqueous granulating liquid (18% gum arabic/82% water solution) is added to the mix with the liquid addition bar on at 900 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing. Once finished, compressed air would be used to flush the system for 10 seconds with the liquid addition bar still on. Next, the liquid addition bar would be turned off and the mixture would continue mixing for another 2 minutes and 30 seconds. Immediately after mixing, the blend would be dumped and sifted through a #12 screen and then added back to the blender. A barrel of material would be dumped from the blender and the organic pre-gelatinized potato starch would be weighed out. This material would then be sifted through a #20 screen two (2) times and then added to the blender. Any hard granules that would not easily pass through the #20 screen would be added back to the blender. The blender would then be jogged for three (3) rotations, a barrel of material from the blender would be dumped, and the Nu-Flow would be weighed out. The remaining material would be sifted through a #20 screen two (2) times and then added to the blender. Any hard granules that will not easily pass through the #20 screen would be added back to the blender. The mixture would then be mixed in the v-blender for 3 minutes and 45 seconds (bar off). Immediately after mixing, the blend would be dumped and sifted through a #12 screen. If possible, push overs would be sifted through the screen by hand. Material that cannot be pushed through the screen by hand is to be milled until 100% of the blend passes through the #12 screen. The resulting batch would range between 1129 kg to 1379 kg.

In another embodiment of the present invention, a method of making an organic dietary supplement comprises blending in a 30 cubic foot v-blender for 1 minute 30 seconds (I-bar off) active ingredients with acceptable excipients, such as Orgen HIM Plus®, organic sea kelp, vitamin K1 renatured, vitamin B12 renatured 207M, vitamin D3, vitamin K2, organic moringa leaf extract, organic wrightia herb extract, organic lantana herb extract, organic pomegranate juice pwd, organic tomato powder, organic turmeric powder, organic pumpkin powder, organic veggie blend, organic fruit blend, and Nu-RICE® (sifted through a #12 screen). The resulting mixture would then be dumped into barrels, sifted through a #12 screen and added to a v-blender for 4 minutes (I-bar off). After the 4 minutes of mixing, the mixture would continue tumbling while an aqueous granulating liquid (18% gum arabic/82% water solution) is added to the mix with the liquid addition bar on at 700 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing. Once finished, compressed air would be used to flush the system for 10 seconds with the liquid addition bar still on. Next, the liquid addition bar would be turned off and the mixture would continue mixing for another 2 minutes. Immediately after mixing, the blend would be dumped and sifted through a #12 screen and then added back to the blender. A barrel of material would be dumped from the blender and the organic pre-gelatinized potato starch would be weighed out. This material would then be sifted through a #20 screen two (2) times and then added to the blender. Any hard granules that would not easily pass through the #20 screen would be added back to the blender. The blender would then be jogged for three (3) rotations, a barrel of material from the blender would be dumped, and the Nu-Flow would be weighed out. The remaining material would be sifted through a #20 screen two (2) times and then added to the blender. Any hard granules that will not easily pass through the #20 screen would be added back to the blender. The mixture would then be mixed in the v-blender for 3 minutes (bar off). Immediately after mixing, the blend would be dumped and sifted through a #12 screen. If possible, push overs would be sifted through the screen by hand. Material that cannot be pushed through the screen by hand is to be milled until 100% of the blend passes through the #12 screen. The resulting batch would range between 452 kg to 551 kg.

In another embodiment of the present invention, a method of making an organic dietary supplement comprises blending in a 5 cubic foot v-blender for 1 minute (I-bar off) active ingredients with acceptable excipients, such as Orgen HIM Plus®, organic sea kelp, vitamin K1 renatured, vitamin B12 renatured 207M, vitamin D3, vitamin K2, organic moringa leaf extract, organic wrightia herb extract, organic lantana herb extract, organic pomegranate juice pwd, organic tomato powder, organic turmeric powder, organic pumpkin powder, organic veggie blend, organic fruit blend, and Nu-RICE® (sifted through a #12 screen. The resulting mixture would then be dumped into barrels, sifted through a #12 screen and added to a v-blender for 3 minutes (I-bar off). After the 3 minutes of mixing, the mixture would continue tumbling while an aqueous granulating liquid (18% gum arabic/82% water solution) is added to the mix and the aqueous granulating solution with the liquid addition bar on at 225 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing is added. Once finished, compressed air would be used to flush the system for 10 seconds with the liquid addition bar still on. Next, the liquid addition bar would be turned off and the mixture would continue mixing for another 1 minute 30 seconds. Immediately after mixing, the blend would be dumped and sifted through a #12 screen and then added back to the blender. A barrel of material would be dumped from the blender and the organic pre-gelatinized potato starch would be weighed out. This material would then be sifted through a #20 screen two (2) times and then added to the blender. Any hard granules that would not easily pass through the #20 screen would be added back to the blender. The blender would then be jogged for three (3) rotations, a barrel of material from the blender would be dumped, and the Nu-Flow would be weighed out. The remaining material would be sifted through a #20 screen two (2) times and then added to the blender. Any hard granules that will not easily pass through the #20 screen would be added back to the blender. The mixture would then be mixed in the v-blender for 2 minutes 30 seconds (bar off). Immediately after mixing, the blend would be dumped and sifted through a #12 screen. If possible, push overs would be sifted through the screen by hand. Material that cannot be pushed through the screen by hand is to be milled until 100% of the blend passes through the #12 screen. The resulting batch would range between 76 kg to 91 kg.

The homogenous mixtures or blends are then compressed using any method suitable in the industry. The mechanical force will define the physical properties of the tablets, especially the crushing strength of the resulting tablet. The mechanical strength interacts with the initial swelling of the tablet and dilution speed of the tablet core. This effect is well known in the art and can be adjusted and controlled during the lifecycle of the product.

In one embodiment, a method of making a non-organic dietary supplement comprises first making the granulating solution which comprises 7% HPC/93% water solution, and then blending in a 75 cubic foot v-blender for 5 minutes (I-bar off) ingredients including: Dextrose non-GMO Cantab®, Strawberry Powder Drum Dried, and Raspberry Spray Dried Powder, Goji Powder Spray Dried, Reishi Mushroom Powder, Maitake Mushroom Powder, ˜⅓ of the Silicon Dioxide, Agaricus Blazei Mushroom Pwd, Arbinogalactan, Hydroxyproplycellulose, Selenium Aac, Copper Glycinate Chelate, Zinc Glycinate Chelate, and Calcium Carbonate Gran DC, all sifted through a #12 screen and added to the blender. After the 5 minutes of mixing, continue tumbling and add the granulating solution with the liquid addition bar on at 1000 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing. Once finished, use compressed air to flush the system for 30 seconds with the liquid addition bar still on. Turn the liquid addition bar off and continue mixing for another 2 minutes and 30 seconds. Immediately after mixing, dump the blend and sift through a #12 screen and add back to the blender. Material that cannot be pushed through the screen by hand is to be milled until 100% of the blend passes through the #12 screen. Next, dump a barrel of material from the blender, followed by weighing out the Melatonin, Orange Essential Oil Powder, and the rest of the Silicon Dioxide, sifting it through a #20 screen two (2) times and then adding it to the blender. Add back to the blender any hard granules that will not easily pass through the #20 screen and mix in the v-blender for 7 minutes and 30 seconds (bar off). Next, dump a barrel of material from the blender, followed by weighing out the Magnesium Stearate, sifting the material through a #20 screen two (2) times and then adding to the blender. Add back to the blender any hard granules that will not easily pass through the #20 screen and mix in the v-blender for 2 minutes and 30 seconds (bar off). Immediately after mixing, dump the blend and sift through a #12 screen. If possible, push overs through the screen by hand. Material that cannot be pushed through the screen by hand is to be milled until 100% of the blend passes through the #12 screen. The resulting batch would range between 1138 kg to 1390 kg.

In another embodiment, a method of making a non-organic dietary supplement comprises first making the granulating solution which comprises 7% HPC/93% water solution, and then blending in a 30 cubic foot v-blender for 4 minutes (I-bar off) ingredients including: Dextrose non-GMO Cantab®, Strawberry Powder Drum Dried, and Raspberry Spray Dried Powder, Goji Powder Spray Dried, Reishi Mushroom Powder, Maitake Mushroom Powder, ˜⅓ of the Silicon Dioxide, Agaricus Blazei Mushroom Pwd, Arbinogalactan, Hydroxyproplycellulose, Selenium Aac, Copper Glycinate Chelate, Zinc Glycinate Chelate, and Calcium Carbonate Gran DC, all sifted through a #12 screen and added to the blender. After the 4 minutes of mixing, continue tumbling and add the granulating solution with the liquid addition bar on at 1000 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing. Once finished, use compressed air to flush the system for 30 seconds with the liquid addition bar still on. Turn the liquid addition bar off and continue mixing for another 2 minutes. Immediately after mixing, dump the blend and sift through a #12 screen and add back to the blender. Material that cannot be pushed through the screen by hand is to be milled until 100% of the blend passes through the #12 screen. Next, dump a barrel of material from the blender, followed by weighing out the Melatonin, Orange Essential Oil Powder, and the rest of the Silicon Dioxide, sifting it through a #20 screen two (2) times and then adding it to the blender. Add back to the blender any hard granules that will not easily pass through the #20 screen and mix in the v-blender for 6 minutes (bar off). Next, dump a barrel of material from the blender, followed by weighing out the Magnesium Stearate, sifting the material through a #20 screen two (2) times and then adding to the blender. Add back to the blender any hard granules that will not easily pass through the #20 screen and mix in the v-blender for 2 minutes (bar off). Immediately after mixing, dump the blend and sift through a #12 screen. If possible, push overs through the screen by hand. Material that cannot be pushed through the screen by hand is to be milled until 100% of the blend passes through the #12 screen. The resulting batch would range between 455 kg to 556 kg.

In another embodiment, a method of making a non-organic dietary supplement comprises first making the granulating solution which comprises 7% HPC/93% water solution, and then blending in a 5 cubic foot v-blender for 3 minutes (I-bar off) ingredients including: Dextrose non-GMO Cantab®, Strawberry Powder Drum Dried, and Raspberry Spray Dried Powder, Goji Powder Spray Dried, Reishi Mushroom Powder, Maitake Mushroom Powder, ˜⅓ of the Silicon Dioxide, Agaricus Blazei Mushroom Pwd, Arbinogalactan, Hydroxyproplycellulose, Selenium Aac, Copper Glycinate Chelate, Zinc Glycinate Chelate, and Calcium Carbonate Gran DC, all sifted through a #12 screen and added to the blender. After the 3 minutes of mixing, continue tumbling and add the granulating solution with the liquid addition bar on at 1000 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing. Once finished, use compressed air to flush the system for 30 seconds with the liquid addition bar still on. Turn the liquid addition bar off and continue mixing for another 1 minute and 30 seconds. Immediately after mixing, dump the blend and sift through a #12 screen and add back to the blender. Material that cannot be pushed through the screen by hand is to be milled until 100% of the blend passes through the #12 screen. Next, dump a barrel of material from the blender, followed by weighing out the Melatonin, Orange Essential Oil Powder, and the rest of the Silicon Dioxide, sifting it through a #20 screen two (2) times and then adding it to the blender. Add back to the blender any hard granules that will not easily pass through the #20 screen and mix in the v-blender for 4 minutes and 30 seconds (bar off). Next, dump a barrel of material from the blender, followed by weighing out the Magnesium Stearate, sifting the material through a #20 screen two (2) times and then adding to the blender. Add back to the blender any hard granules that will not easily pass through the #20 screen and mix in the v-blender for 1 minute and 30 seconds (bar off). Immediately after mixing, dump the blend and sift through a #12 screen. If possible, push overs through the screen by hand. Material that cannot be pushed through the screen by hand is to be milled until 100% of the blend passes through the #12 screen. The resulting batch would range between 76 kg to 92 kg.

In one embodiment, a method of making a non-organic dietary supplement comprises first making the granulating solution which comprises 7% HPC/93% water solution, and then blending in a 75 cubic foot v-blender for 5 minutes (I-bar off) ingredients including: Dextrose non-GMO Cantab®, Strawberry Powder Drum Dried, Raspberry Spray Dried Powder, Goji Powder Spray Dried, Reishi Mushroom Powder, Maitake Mushroom Powder, ˜⅓ of the Silicon Dioxide, Agaricus Blazei Mushroom Pwd, Arbinogalactan, Hydroxyproplycellulose, Selenium Aac, Copper Glycinate Chelate, Zinc Glycinate Chelate, and Calcium Carbonate Gran DC, all sifted through a #12 screen and added to the blender. After the 5 minutes of mixing, continue tumbling and add the granulating solution with the liquid addition bar on at 1000 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing. Once finished, use compressed air to flush the system for 30 seconds with the liquid addition bar still on. Turn the liquid addition bar off and continue mixing for another 2 minutes and 30 seconds. Immediately after mixing, dump the blend and sift through a #12 screen and add back to the blender. Material that cannot be pushed through the screen by hand is to be milled until 100% of the blend passes through the #12 screen. Next, sift and weigh the Croscarmellose Sodium and add to the blender. Mix in the v-blender for 5 minutes (bar off). Next, dump a barrel of material from the blender, followed by weighing out the Silicon Dioxide and sifting it through a #20 screen two (2) times and then adding to the blender. Add back to the blender any hard granules that will not easily pass through the #20 screen. Next, jog the blender for three (3) rotations. Afterwards, dump a barrel of material from the blender, followed by weighing out the Stearic Acid and sifting it through a #20 screen two (2) times and then adding to the blender. Add back to the blender any hard granules that will not easily pass through the #20 screen. Mix in the v-blender for 3 minutes and 45 seconds (bar off). Next, dump a barrel of material from the blender, followed by weighing out the Magnesium Stearate, sifting it through a #20 screen two (2) times and then adding to the blender. Add back to the blender any hard granules that will not easily pass through the #20 screen. Mix in the v-blender for 2 minutes and 30 seconds (bar off). Immediately after mixing, dump the blend and sift through a #12 screen. If possible, push overs through the screen by hand. Material that cannot be pushed through the screen by hand is to be milled until 100% of the blend passes through the #12 screen. The resulting batch would range between 1118 kg to 1300 kg.

In another embodiment, a method of making a non-organic dietary supplement comprises first making the granulating solution which comprises 7% HPC/93% water solution, and then blending in a 30 cubic foot v-blender for 4 minutes (I-bar off) ingredients including: Dextrose non-GMO Cantab®, Strawberry Powder Drum Dried, Raspberry Spray Dried Powder, Goji Powder Spray Dried, Reishi Mushroom Powder, Maitake Mushroom Powder, ˜⅓ of the Silicon Dioxide, Agaricus Blazei Mushroom Pwd, Arbinogalactan, Hydroxyproplycellulose, Selenium Aac, Copper Glycinate Chelate, Zinc Glycinate Chelate, and Calcium Carbonate Gran DC, all sifted through a #12 screen and added to the blender. After the 4 minutes of mixing, continue tumbling and add the granulating solution with the liquid addition bar on at 1000 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing. Once finished, use compressed air to flush the system for 30 seconds with the liquid addition bar still on. Turn the liquid addition bar off and continue mixing for another 2 minutes. Immediately after mixing, dump the blend and sift through a #12 screen and add back to the blender. Material that cannot be pushed through the screen by hand is to be milled until 100% of the blend passes through the #12 screen. Next, sift and weigh the Croscarmellose Sodium and add to the blender. Mix in the v-blender for 4 minutes (bar off). Next, dump a barrel of material from the blender, followed by weighing out the Silicon Dioxide and sifting it through a #20 screen two (2) times and then adding to the blender. Add back to the blender any hard granules that will not easily pass through the #20 screen. Next, jog the blender for three (3) rotations. Afterwards, dump a barrel of material from the blender, followed by weighing out the Stearic Acid and sifting it through a #20 screen two (2) times and then adding to the blender. Add back to the blender any hard granules that will not easily pass through the #20 screen. Mix in the v-blender for 3 minutes (bar off). Next, dump a barrel of material from the blender, followed by weighing out the Magnesium Stearate, sifting it through a #20 screen two (2) times and then adding to the blender. Add back to the blender any hard granules that will not easily pass through the #20 screen. Mix in the v-blender for 2 minutes (bar off). Immediately after mixing, dump the blend and sift through a #12 screen. If possible, push overs through the screen by hand. Material that cannot be pushed through the screen by hand is to be milled until 100% of the blend passes through the #12 screen. The resulting batch would range between 447 kg to 520 kg.

The organic and non-organic dietary supplement can further be coated. Coating the tablet may be performed by any known process. A coating for the tablet disclosed herein can be any suitable coating, such as, for example, a functional or a non-functional coating, or multiple functional or non-functional coatings. By “functional coating” is meant to include a coating that modifies the release properties of the total formulation, for example, a sustained-release coating. By “non-functional coating” is meant to include a coating that is not a functional coating, for example, a cosmetic coating. A non-functional coating can have some impact on the release of the active agent due to the initial dissolution, hydration, perforation of the coating, etc., but would not be considered to be a significant deviation from the non-coated composition. In one embodiment, the organic coating is included in an amount between about 0.6 wt % and 1.0 wt % of the formulation. In an embodiment, the organic coating is developed by Colorcon, Inc. called Opadry Nutrapure™.

All of the references cited above, as well as all references cited herein, are incorporated herein by reference in their entireties.

While the invention has been illustrated and described in detail in above, such illustration and description are to be considered illustrative or exemplary and not restrictive. It will be understood that changes and modifications may be made by those of ordinary skill within the scope and spirit of the following claims. In particular, the present invention covers further embodiments with any combination of features from different embodiments described above and below.

The present invention is additionally described by way of the following illustrative non-limiting examples that provide a better understanding of the present invention and of its many advantages. The following examples are included to demonstrate preferred embodiments of the invention. It should be appreciated by those of skill in the art that the techniques disclosed in the examples which follow represent techniques used in the present invention to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

### Example 1: Organic Womens Multivitamin Tablet

This example involves an Organic Womens Multivitamin Tablet formula that is certified by Quality Certification Services (QCS) as 95% organic. This formula is dominated by raw material Orgen HIM Plus® from Orgenetics, Inc. Orgen HIM Plus® is a customized blend of spray dried, organically-derived vitamins and minerals created using a proprietary water extraction method.

As stated in the background, the active raw materials in the formula have an abundance of fine and ultra-fine particles which makes them flow poorly and have limited compressibility. For example, Orgen HIM Plus® is a fine powder (typically more than 80% of the material is finer than 106 μm). The flowability of the powder is very poor (typical Carr Compressibility Index values of greater than 40).

TABLE 2
Active Ingredients in the Organic Women's Multivitamin Tablet
Formula

| Ingredient | Supplier | mg/tablet |
|---|---|---|
| Orgen Him Plus ® | Orgenetics, Inc. | 525.000 |
| ORGANIC MORINGA | Orgenetics, Inc. | 1.000 |
| LEAF EXTRACT | | |
| ORGANIC WRIGHTIA HERB | Orgenetics, Inc. | 1.000 |
| EXTRACT | | |
| ORGANIC LANTANA HERB | Orgenetics, Inc. | 1.000 |
| EXTRACT | | |
| ORGANIC CURRY LEAVES | Orgenetics, Inc. | 55.556 |
| EXTRACT | | |
| VITAMIN K1 RENATURED | Grow Company, Inc. | 9.000 |
| VITAMIN B12 RENATURED 207M | Grow Company, Inc. | 2.640 |
| VITAMIN D3 | Grow Company, Inc. | 13.000 |
| VITAMIN K2 | Grow Company, Inc. | 0.462 |
| ORGANIC VEGGIE BLEND | Futureceuticals | 25.000 |
| ORGANIC FRUIT BLEND | Futureceuticals | 25.000 |
| BETA CAROTENE VEG | Lycored Bio, Ltd. | 16.538 |
| BEADLETS | | |
| | total mg | 675.196 |

We first attempted to formulate a typical direct compression formula using organic excipients in place of those one would normally use in a dietary or nutritional supplement (Table 3). The design principle of this formula was simple; counterbalance the poor flowability and limited compressibility imparted by the high load of active ingredients with the addition of TapiOK®, an organic dextrose derived from tapioca (representative certificate of analysis—Attachment B). TapiOK® is a specialty dextrose that is agglomerated, highly compressible, and granular. Importantly, this material has excellent flowability.

TABLE 3
Organic Women's Multivitamin Full Formula

| Ingredient | Supplier | mg/tablet |
|---|---|---|
| Orgen Him Plus ® | Orgenetics, Inc. | 525.000 |
| ORGANIC MORINGA LEAF | Orgenetics, Inc. | 1.000 |
| EXTRACT | | |
| ORGANIC WRIGHTIA HERB | Orgenetics, Inc. | 1.000 |
| EXTRACT | | |
| ORGANIC LANTANA HERB | Orgenetics, Inc. | 1.000 |
| EXTRACT | | |
| ORGANIC CURRY LEAVES | Orgenetics, Inc. | 55.556 |
| EXTRACT | | |
| VITAMIN K1 RENATURED | Grow Company, Inc. | 9.000 |
| VITAMIN B12 RENATURED 207M | Grow Company, Inc. | 2.640 |
| VITAMIN D3 | Grow Company, Inc. | 13.000 |
| VITAMIN K2 | Grow Company, Inc. | 0.462 |
| ORGANIC VEGGIE BLEND | Futureceuticals | 25.000 |
| ORGANIC FRUIT BLEND | Futureceuticals | 25.000 |
| BETA CAROTENE VEG | Lycored Bio, Ltd. | 16.538 |
| BEADLETS | | |
| ORGANIC PREGELATINIZED | Marroquin Organic | 29.500 |
| POTATO STARCH | International, Inc. | |
| PREHYDRATED ORGANIC | TiC Gums | 59.000 |
| GUM ARABIC | | |
| TapiOK ® ORGANIC | Ciranda | 682.340 |
| TAPIOCA DEXTROSE | | |
| ORGANIC RICE EXTRACT | Ribus, Inc. | 29.500 |
| (Nu-RICE ®) | | |
| ORGANIC RICE CONCENTRATE | Ribus, Inc. | 14.750 |
| (Nu-Flow ®) | | |
| | total mg | 1,490.286 |

Additional organic excipients (organic pre-gelatinized potato starch, organic gum arabic, Nu-Flow®, and Nu-RICE®) were added to the formula to facilitate disintegration, improve compression, help prevent caking, and provide lubrication.

Each individual raw material was screened and the dry powder blends mixed using twin-shell v-blenders consistent with typical direct compression manufacturing processes.

This formula was compressed into tablets using 0.8750×0.3750 inch modified elongated D tooling (Natoli HOB #70070) using an 8-ton Manesty Mark II tablet presses without pre-compression.

Several million tablets of the Organic Women's Multivitamin Tablet formula referenced above were produced between the Spring of 2014 and the Spring of 2016. During this two-year period, production experienced inconsistent run-ability of this product on the tablet presses, which resulted in product quality issues. Poor compressibility and flowability of the blend often led to manufacturing defects such as capping, high friability, broken/soft tablets, and low production yields.

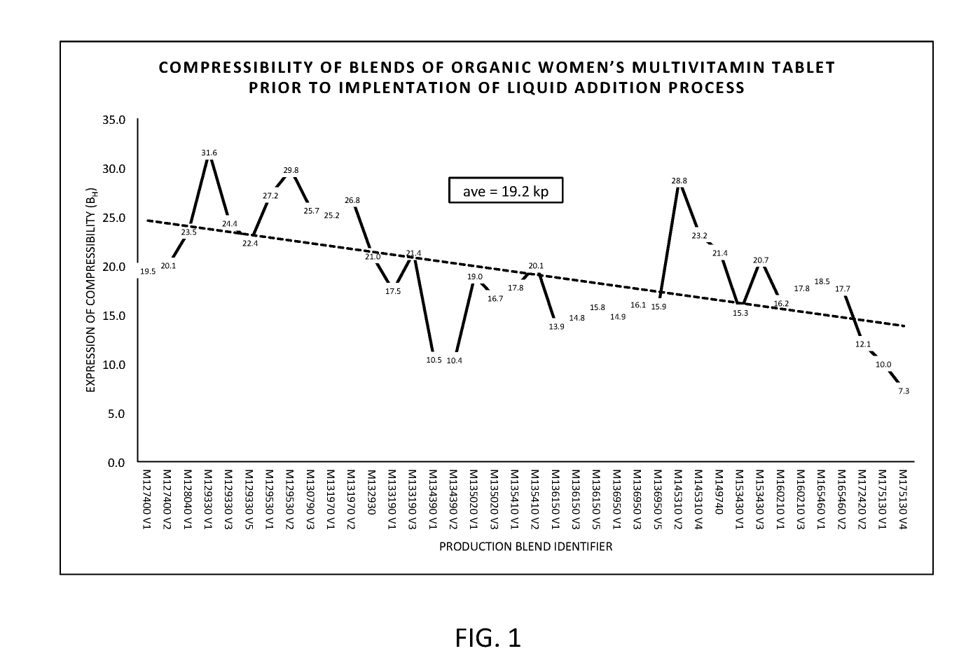

FIG. 1 shows the compressibility of production blends from Spring of 2014 to Spring of 2016, prior to implementation of the invention. For this paper, compressibility is defined as the relationship between breaking strength (hardness) and compaction pressure. Compressibility of each blend was measured by first filling a 0.8750×0.3750 inch modified, elongated, oval die with powder equal to the fill weight of the tablet (˜1490 mg). Then, the powder was compressed into tablets using 0.8750×0.3750 inch modified, elongated upper and lower tooling via a Carver Press, model M. Tablets were compressed at progressively increasing applied pressure (psi), then measured for hardness (kp) using a Varian VK200 tablet hardness tester. For ease of interpretation, the data is shown in FIG. 1 as a simple and novel expression of compressibility, β_{H}. β_{H} is the average hardness of tablets compressed at 750 PSI and 1000 PSI for each blend tested.

Blends made in the early to middle part of 2014 had acceptable compressibility, but were still difficult to manufacture. Subsequent blends had progressively-worse compressibility over time. We attribute this trend to a regression in compressibility of the Orgen Him Plus® material in conjunction with batch to batch inconsistencies of organic raw materials in general. The average of this expression of compressibility (β_{H}) over this time is 19.2. By the end of 2015 and beginning of 2016, blend-related production problems had gotten to a point that the tablet presses and tooling were being damaged to make the product.

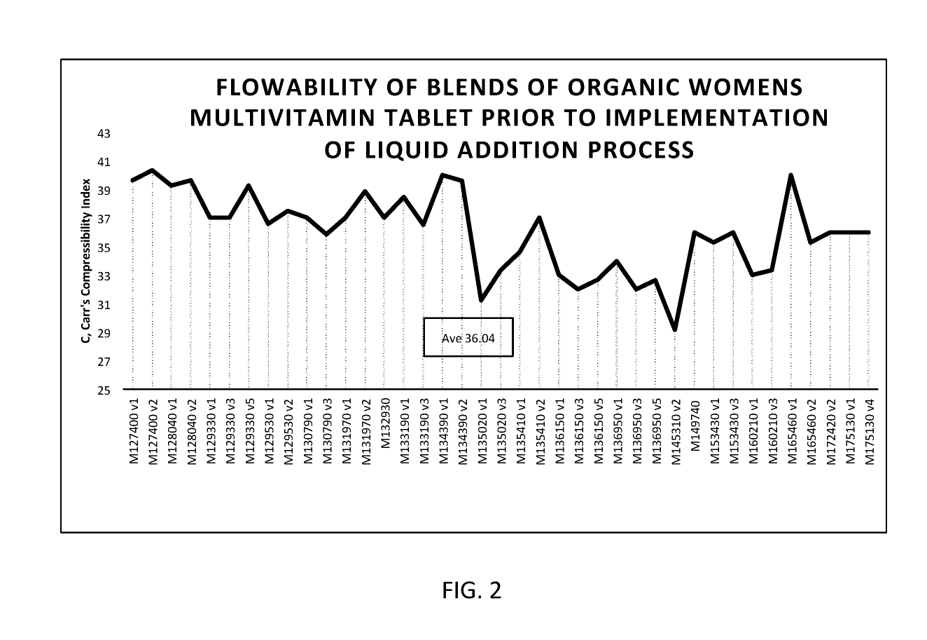

Flowability of a powder blend is another important measurable physical attribute that can demonstrate suitability for tablet manufacturing. FIG. 2 shows the flowabilty of production blends of Organic Womens Multivitamin Tablet from Spring of 2014 to Spring of 2016 prior to implementation of the invention. Flowability of each powder blend can be expressed as Carr's

Compressibility Index (USP 616), calculated by the formula:

$$C = 100 \frac{{V}_{B} - {V}_{T}}{{V}_{B}}$$

where V_{B} is the unsettled apparent volume and V_{T} is the final tapped volume (500 taps) of ˜15 grams of powder in a 50 mL graduated cylinder.

In general, C of the blends fluctuated between ˜30 and 40, with an average C of 36.04. As indicated by their C numbers, these blends displayed extremely poor flowability, and mechanical assistance was needed to facilitate powder flow through the hoppers on the tablet presses. Even with assisted flow, tablet press speeds needed to be at or near their mechanical minimums to avoid large weight variation.

In April of 2016, the problems had grown to the point that we were unable to compress order M175130 into tablets. Compressibility, β_{H}, of M175130 was between 7 and 10 (very bad), and flowability, C, was 36 (very bad).

### Example 2: First Application of the Invention

An aqueous granulating solution was created consisting of 18% organic gum arabic and 82% RODI water. 1.83% (by weight) of the aqueous granulation solution was added to the blends of M175130 in a 30 cu ft V-blender using a two-disc cantilever intensifier-bar (I-bar) liquid addition assembly that comes standard with a liquids/solids twin shell v-blender from Patterson-Kelley.

TABLE 4
Organic Women's Multivitamin Full Formula showing
the concentrations and ranges of the ingredients

| Ingredient | Function | w % | Range |
|---|---|---|---|
| Orgen Him Plus ® | Active | 45.3 | 40.0-50.0 |
| ORGANIC MORINGA LEAF | ingredients | | |
| EXTRACT | | | |
| ORGANIC WRIGHTIA HERB | | | |
| EXTRACT | | | |
| ORGANIC LANTANA HERB | | | |
| EXTRACT | | | |
| ORGANIC CURRY LEAVES | | | |
| EXTRACT | | | |
| VITAMIN K1 RENATURED | | | |
| VITAMIN B12 RENATURED 207M | | | |
| VITAMIN D3 | | | |
| VITAMIN K2 | | | |
| ORGANIC VEGGIE BLEND | | | |
| ORGANIC FRUIT BLEND | | | |
| BETA CAROTENE VEG | | | |
| BEADLETS | | | |
| ORGANIC PREGELATINIZED | Disintegrant | 1.97 | 1.0-3.0 |
| POTATO STARCH | | | |
| PREHYDRATED ORGANIC | Binder | 3.95 | 2.0-8.0 |
| GUM ARABIC | | | |
| TapiOK ® ORGANIC | Glidant | 45.79 | 40.0-50.0 |
| TAPIOCA DEXTROSE | | | |
| ORGANIC RICE EXTRACT | Lubricant | 1.97 | 0.5-3.0 |
| (Nu-RICE ®) | | | |
| ORGANIC RICE CONCENTRATE | Anti-caking | 0.99 | 0.5-3.0 |
| (Nu-Flow ® | | | |
| Aqueous granulating solution | Granulating | 0.75 | 0.5-2.0 |
| (Prehydrated organic gum | solution | | |
| arabic 18% by weigh + RODI water) | | | |
| | total mg | 100.00 | 100.00 |

This was achieved by the following process:

The bulk powder mix M175130 was added to the blender and tumbled for 4 minutes with the I-bar off.

After the 4 minutes of tumbling, the I-bar was activated with the blender still tumbling and the granulating solution was delivered to into the liquid addition assembly at 0.700 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

After delivery of the granulating fluid, the compressed air was blown through the line for ten seconds to evacuate as much of the granulating solution as we could.

Blending continued for two more minutes with the I-bar off.

At the end of the blending cycle, the mix was dumped from the blender into clean, poly-lined barrels. The final blend was then sifted using a #12 screen and any agglomerates resulting from the granulation process pushed through the screen by hand.

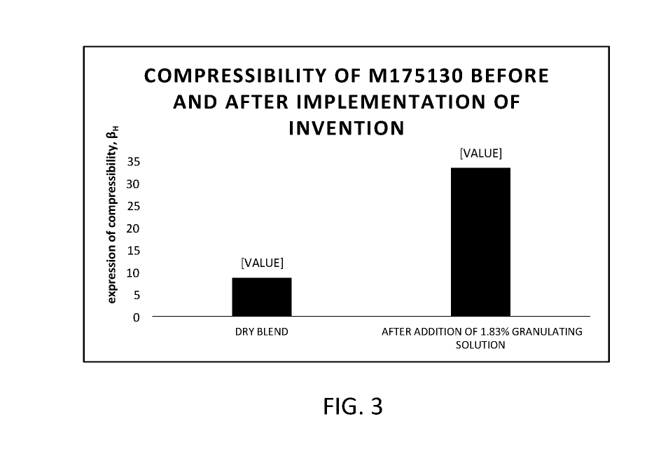

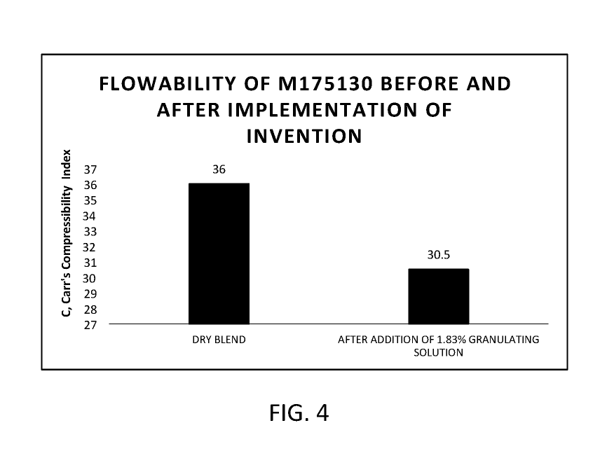

Testing of the final blends of M175130 showed distinct improvements in both compressibility and flowability (See FIGS. 3 and 4).

Compressibility (β_{H}) of the blend improved by ˜284%, while flowability (C) of the blend improved by ˜15%. High quality tablets were made from blend M175130 in production after implementation of this invention.

### Example 3: Optimization of the Invention

Since the initial application of the preliminary invention, the process has been optimized. Several batches of the Organic Women's Multivitamin Tablet formula have been successfully produced utilizing the final iteration of the invention.

Summary of the Process:

0.6% (by weight) of an aqueous granulating solution consisting of 18% organic gum arabic and 82% RODI water is added to the powder blend prior to the addition of the Nu-Flow® and organic pre-gelatinized potato starch in a Patterson-Kelley, liquid-solids, twin-shell V-blender using a two-disc cantilever intensifier-bar (I-bar) liquid addition assembly that comes standard with these blenders. The granulated blend is sifted through a #12 screen to eliminate large agglomerates. The sifted material is added back to the blender. Nu-Flow® and organic pre-gelatinized potato starch are added to the blend. The process has been verified in 5, 30, and 75 cu ft sized blenders.

Method:

75 Cubic Foot V-Blender

Batch Range—1007 kg to 1230 kg

Stage 1 (making the granulating solution):

1. Prepare the 18% gum arabic/82% water solution in advance of blending.

Stage 2:

1. Weigh out Orgen HIM Plus®, vitamin K1 renatured 207M, vitamin B12 renatured, vitamin D3, vitamin K2, organic moringa leaf extract, organic wrightia herb extract, organic lantana herb extract, organic curry leaves extract, organic veggie blend, organic fruit blend, and Nu-RICE®. Sift these materials through a #20 screen and add to the blender.

2. Weigh out the beta carotene veg beadlets, Pre-hydrated organic gum arabic, Tapiok® organic tapioca dextrose. Sift these materials through a #12 screen and add to the blender.

3. Mix in the v-blender for 2 minutes (I-bar off).

Stage 3:

1. Into barrels, dump the blend.

2. Sift the dumped blend through a #12 screen and add to the blender.

3. Mix in the v-blender for 5 minutes (I-bar off).

Stage 4:

1. After the 5 minutes of mixing in Stage 3, continue tumbling and add the granulating solution with the liquid addition bar on at 900 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 10 seconds with the liquid addition bar still on.

3. Turn the liquid addition bar off and continue mixing for another 2 minutes and 30 seconds.

Stage 5:

1. Immediately after mixing, dump the blend and sift through a #12 screen and add back to the blender.

2. Dump a barrel of material from the blender.

3. Into the barrel of dumped blend, weigh out the organic pre-gelatinized potato starch.

4. Sift the material from step 3 through a #20 screen two (2) times and then add to the blender. Add back to the blender any hard granules that will not easily pass through the #20 screen.

5. Jog the blender for three (3) rotations.

6. Dump a barrel of material from the blender.

7. Into the barrel of dumped blend, weigh out the Nu-Flow®.

8. Sift the material from step 7 through a #20 screen two (2) times and then add to the blender. Add back to the blender any hard granules that will not easily pass through the #20 screen.

9. Mix in the v-blender for 3 minutes and 45 seconds (bar off).

Stage 6:

1. Immediately after mixing, dump the blend and sift through a #12 screen. If possible, push overs through the screen by hand. Material that cannot be pushed through the screen by hand is to be milled until 100% of the blend passes through the #12 screen.

30 Cubic Foot V-Blender

Batch Range—403 kg to 492 kg

Stage 1 (making the granulating solution):

1. Prepare the 18% gum arabic/82% water solution in advance of blending.

Stage 2:

1. Weigh out Orgen HIM Plus®, vitamin K1 renatured 207M, vitamin B12 renatured, vitamin D3, vitamin K2, organic moringa leaf extract, organic wrightia herb extract, organic lantana herb extract, organic curry leaves extract, organic veggie blend, organic fruit blend, and Nu-RICE®. Sift these materials through a #20 screen and add to the blender.

2. Weigh out the beta carotene veg beadlets, pre-hydrated organic gum arabic, Tapiok® organic tapioca dextrose. Sift these materials through a #12 screen and add to the blender.

3. Mix in the v-blender for 1 minute and 30 seconds (I-bar off).

Stage 3:

1. Into barrels, dump the blend.

2. Sift the dumped blend through a #12 screen and add to the blender.

3. Mix in the v-blender for 4 minutes (I-bar off).

Stage 4.

1. After the 5 minutes of mixing in Stage 3, continue tumbling and add the granulating solution with the liquid addition bar on at 700 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 10 seconds with the liquid addition bar still on.

3. Turn the liquid addition bar off and continue mixing for another 2 minutes.

Stage 5:

1. Immediately after mixing, dump the blend and sift through a #12 screen and add back to the blender.

2. Dump a barrel of material from the blender

3. Into the barrel of dumped blend, weigh out the organic pre-gelatinized potato starch.

4. Sift the material from step 3 through a #20 screen two (2) times and then add to the blender. Add back to the blender any hard granules that will not easily pass through the #20 screen.

5. Jog the blender for three (3) rotations.

6. Dump a barrel of material from the blender.

7. Into the barrel of dumped blend, weigh out the Nu-Flow®.

8. Sift the material from step 7 through a #20 screen two (2) times and then add to the blender. Add back to the blender any hard granules that will not easily pass through the #20 screen.

9. Mix in the v-blender for 3 minutes (bar off).

Stage 6:

1. Immediately after mixing, dump the blend and sift through a #12 screen. If possible, push overs through the screen by hand. Material that cannot be pushed through the screen by hand is to be milled until 100% of the blend passes through the #12 screen.

5 Cubic Foot V-Blender

Batch Range—68 kg to 82 kg

Stage 1 (Making the Granulating Solution):

1. Prepare the 18% gum arabic/82% water solution in advance of blending.

Stage 2:

1. Weigh out Orgen HIM Plus®, vitamin K1 renatured 207M, vitamin B12 renatured, vitamin D3, vitamin K2, organic moringa leaf extract, organic wrightia herb extract, organic lantana herb extract, organic curry leaves extract, organic veggie blend, organic fruit blend, and Nu-RICE®. Sift these materials through a #20 screen and add to the blender.

2. Weigh out the beta carotene veg beadlets, pre-hydrated organic gum arabic, Tapiok® organic tapioca dextrose. Sift these materials through a #12 screen and add to the blender.

3. Mix in the v-blender for 1 minute (I-bar off).

Stage 3:

1. Into barrels, dump the blend.

2. Sift the dumped blend through a #12 screen and add to the blender.

3. Mix in the v-blender for 3 minutes (I-bar off).

Stage 4:

1. After the 5 minutes of mixing in Stage 3, continue tumbling and add the granulating solution with the liquid addition bar on at 225 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 10 seconds with the liquid addition bar still on.

3. Turn the liquid addition bar off and continue mixing for another 1 minute and 30 seconds.

Stage 5:

1. Immediately after mixing, dump the blend and sift through a #12 screen and add back to the blender.

2. Dump a barrel of material from the blender

3. Into the barrel of dumped blend, weigh out the organic pre-gelatinized potato starch.

4. Sift the material from step 3 through a #20 screen two (2) times and then add to the blender. Add back to the blender any hard granules that will not easily pass through the #20 screen.

5. Jog the blender for three (3) rotations.

6. Dump a barrel of material from the blender.

7. Into the barrel of dumped blend, weigh out the Nu-Flow®.

8. Sift the material from step 7 through a #20 screen two (2) times and then add to the blender. Add back to the blender any hard granules that will not easily pass through the #20 screen.

9. Mix in the v-blender for 2 minutes and 30 seconds (bar off).

Stage 6

1. Immediately after mixing, dump the blend and sift through a #12 screen. If possible, push overs through the screen by hand. Material that cannot be pushed through the screen by hand is to be milled until 100% of the blend passes through the #12 screen.

Results:

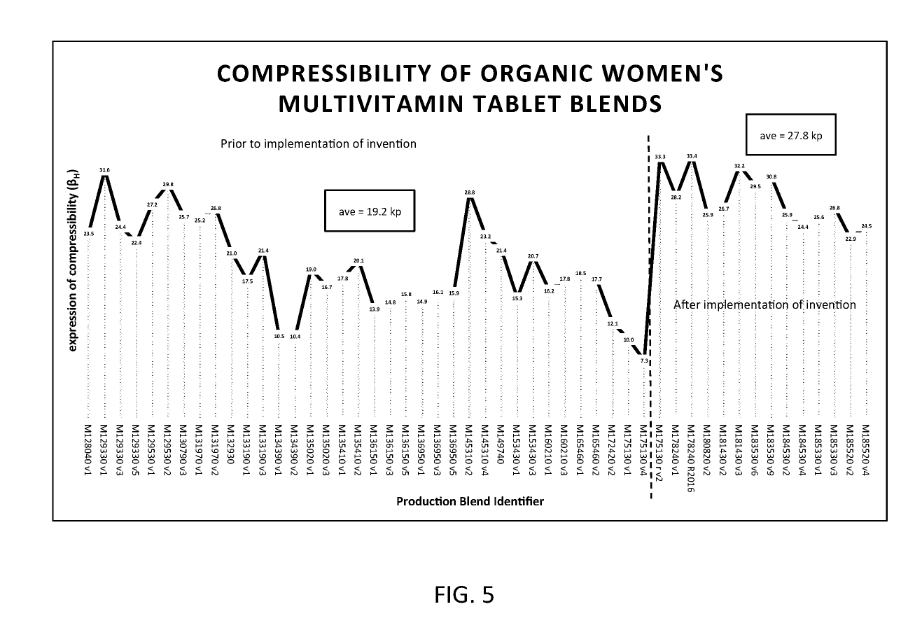

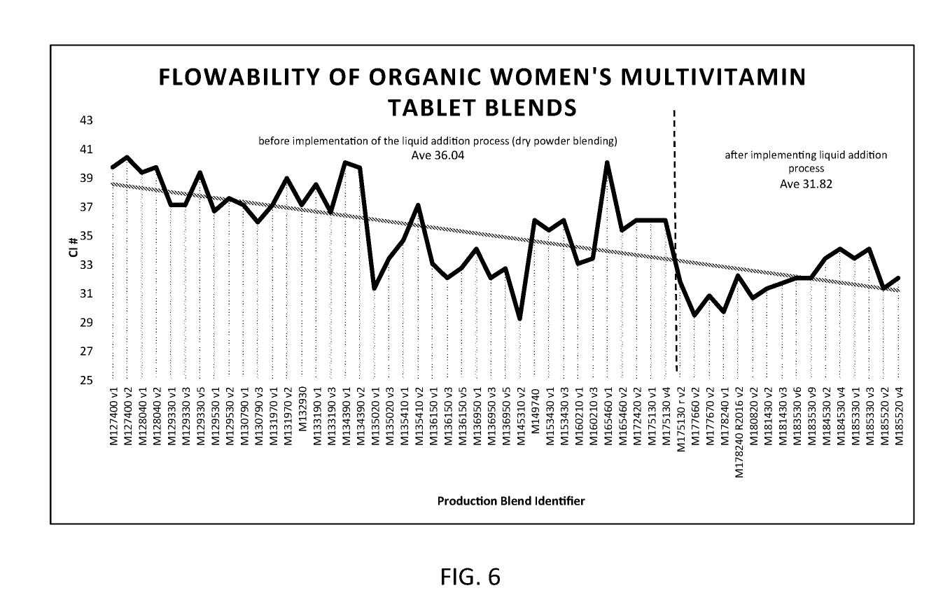

Fourteen batches of Organic Women's Multivitamin Tablet have been successfully produced utilizing the invention through the end of 2017. FIGS. 5 and 6 show significant improvement to compressibility and flowability, respectively.

Prior to the invention, the average compressibility of production blends of Organic Women's Multivitamin Tablet was 19.2 kp. After implementing the invention, the average compressibility of production blends of this same formula was 27.8 kp, an improvement of ˜45%.

Prior to the invention, the average flowability of production blends of Organic Women's Multivitamin Tablet was 36.04. After implementing the invention, the average flowability of production blends of this same formula was 31.82, an improvement of ˜13%.

### Example 4: Organic Men's 40 Plus Multivitamin Tablet

This study involves an Organic Men's 40 Plus Multivitamin Tablet formula that is certified by Quality Certification Services (QCS) as 95% organic. This formula is dominated by a combination of Orgen Him Plus® and seven (7) organic fruit and vegetable powders.

The active raw materials in this Organic Men's 40 Plus Multivitamin Tablet formula have an abundance of fine and ultra-fine particles which makes them flow poorly and have limited compressibility.

TABLE 5
Active Ingredients in the Organic Men's 40 Plus
Multivitamin Tablet Formula.

| Ingredient | Supplier | mg/tablet |
|---|---|---|
| Orgen Him Plus ® | Orgenetics, Inc. | 312.500 |
| ORGANIC SEA KELP | Thorvin, Inc | 25.000 |
| VITAMIN K1 RENATURED | Grow Company, Inc. | 4.200 |
| VITAMIN B12 RENATURED 207M | Grow Company, Inc. | 6.600 |
| VITAMIN D3 | Health Specialties | 6.500 |
| | Manufacturing, Inc | |
| VITAMIN K2 | Orgenetics, Inc. | 0.462 |
| ORGANIC MORINGA LEAF | Orgenetics, Inc. | 0.500 |
| EXTRACT | | |
| ORGANIC WRIGHTIA HERB | Orgenetics, Inc. | 0.500 |
| EXTRACT | | |
| ORGANIC LANTANA HERB | Orgenetics, Inc. | 0.500 |
| EXTRACT | | |
| Organic Pomegranate Juice Pwd | NP Nutra | 25.000 |
| ORGANIC TOMATO POWDER | various | 25.000 |
| ORGANIC TURMERIC POWDER | various | 25.000 |
| ORGANIC PUMPKIN POWDER | various | 25.000 |
| ORGANIC VEGGIE BLEND | Futureceuticals | 50.000 |
| ORGANIC FRUIT BLEND | Futureceuticals | 50.000 |
| BETA CAROTENE VEG | Lycored Bio, Ltd. | 9.844 |
| BEADLETS | | |
| | total mg | 566.606 |

As with the Organic Women's Multivitamin Tablet, this formula was initially constructed for direct compression with a high load of TapiOK® to facilitate flow and compressibility of the blend.

Additional organic excipients (organic pre-gelatinized potato starch, organic gum arabic, Nu-Flow®, and Nu-RICE®) were added to the formula to facilitate disintegration, improve compression, help prevent caking, and provide lubrication (see Table 6).

TABLE 6
Organic Men's 40 Plus Multivitamin Tablet Full Formula

| Ingredient | Supplier | mg/tablet |
|---|---|---|
| Orgen Him Plus ® | Orgenetics, Inc. | 312.500 |
| ORGANIC SEA KELP | Thorvin, Inc | 25.000 |
| VITAMIN K1 RENATURED | Grow Company, Inc. | 4.200 |
| VITAMIN B12 RENATURED 207M | Grow Company, Inc. | 6.600 |
| VITAMIN D3 | Health Specialties | 6.500 |
| | Manufacturing, Inc | |
| VITAMIN K2 | Orgenetics, Inc. | 0.462 |
| ORGANIC MORINGA LEAF | Orgenetics, Inc. | 0.500 |
| EXTRACT | | |
| ORGANIC WRIGHTIA HERB | Orgenetics, Inc. | 0.500 |
| EXTRACT | | |
| ORGANIC LANTANA HERB | Orgenetics, Inc. | 0.500 |
| EXTRACT | | |
| Organic Pomegranate Juice Pwd | NP Nutra | 25.000 |
| ORGANIC TOMATO POWDER | various | 25.000 |
| ORGANIC TURMERIC POWDER | various | 25.000 |
| ORGANIC PUMPKIN POWDER | various | 25.000 |
| ORGANIC VEGGIE BLEND | Futureceuticals | 50.000 |
| ORGANIC FRUIT BLEND | Futureceuticals | 50.000 |
| BETA CAROTENE VEG | Lycored Bio, Ltd. | 9.844 |
| BEADLETS | | |
| PREHYDRATED GUM | TIC Gums | 108.725 |
| ARABIC ORGANIC | | |
| TapiOK ® ORGANIC | Ciranda | 664.669 |
| TAPIOCA DEXTROSE | | |
| ORGANIC RICE EXTRACT | Ribus, Inc. | 28.000 |
| (Nu-RICE ®) | | |
| ORGANIC POTATO STARCH | Marroquin Organic | 28.000 |
| PREGELAT | International | |
| ORGANIC RICE CONCENTRATE | Ribus, Inc. | 14.000 |
| (Nu-Flow ®) | | |
| | total mg | 1,410.000 |

Each individual raw material was screened and the dry powder blends mixed using twin-shell v-blenders consistent with typical direct compression manufacturing processes.

This formula was compressed into tablets using 0.8750×0.3750 inch modified elongated D tooling (Natoli HOB #70070) using an 8-ton Manesty Mark II tablet presses without pre-compression.

Several million tablets of the Organic Men's 40 Plus Multivitamin Tablet formula referenced above were produced between the Spring of 2014 and the Spring of 2016. During this two-year period, production experienced inconsistent run-ability of this product on the tablet presses which resulted in product quality issues. Poor compressibility and flowability of the blend often led to manufacturing defects such as capping, high friability, broken/soft tablets, and low production yields.

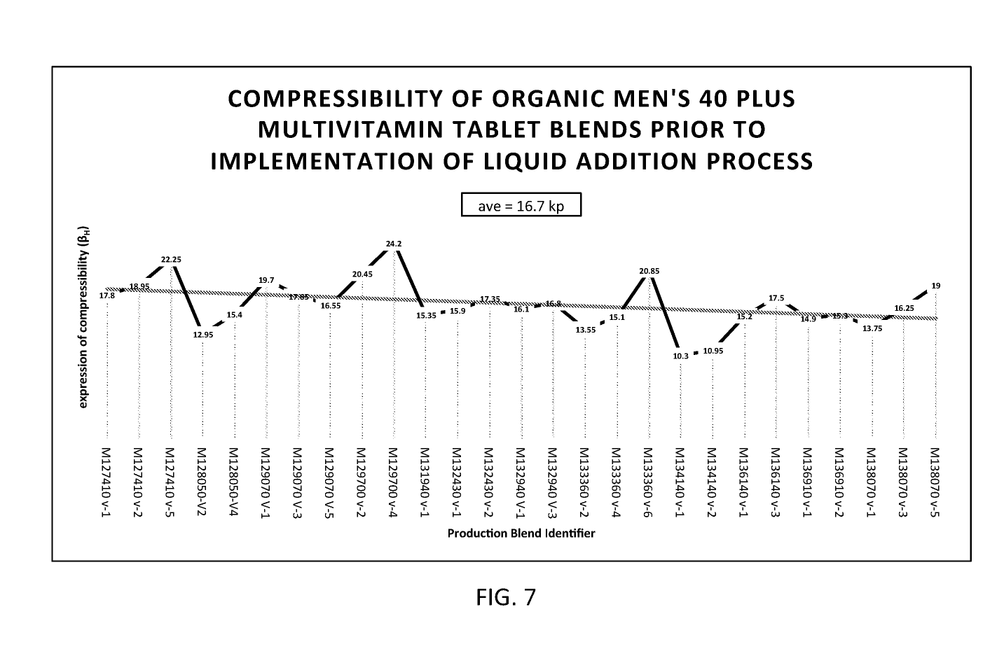

FIG. 7 shows the compressibility, expressed as β_{H}, of production blends of Organic Men's 40 Plus Multivitamin Tablet from Spring 2014 to Spring 2016, prior to the implementation of the invention.

Blends of Organic Men's 40 Plus Multivitamin Tablet made in the early to middle part of 2014 had acceptable compressibility, but were still difficult to manufacture. Subsequent blends had progressively-worse compressibility over time. We attribute this trend to a regression in compressibility of the Orgen Him Plus® material in conjunction with batch to batch inconsistencies of organic raw materials in general. The average of this expression of compressibility (β_{H}) over this time is 16.7.

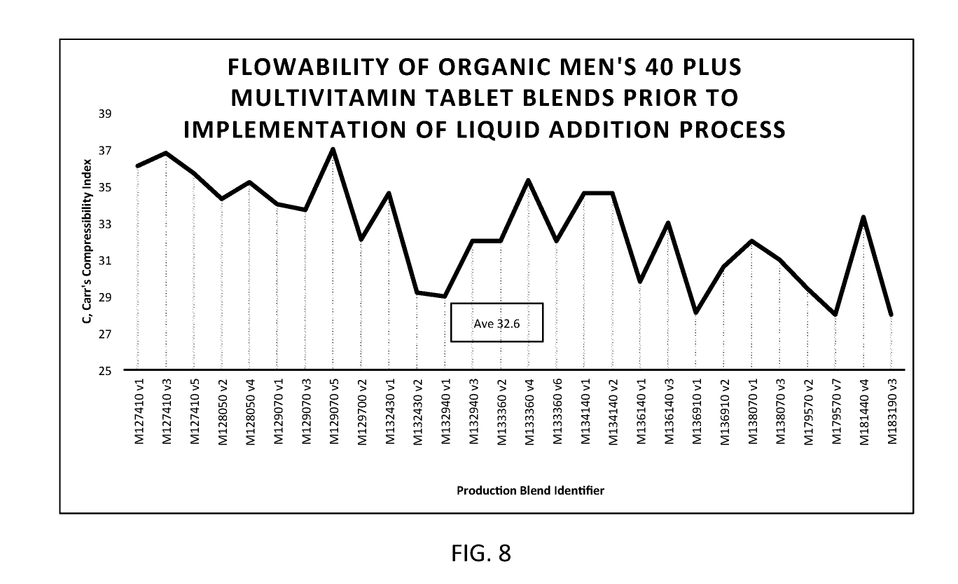

FIG. 8 shows the flowability, as expressed as C, of production blends of Organic Men's 40 Plus Multivitamin Tablet from Spring 2014 to Spring 2016, prior to the implementation of the invention.

In general, C of blends ranged between ˜28 and 37, with an average C of 32.6. As indicated by their C numbers, these blends displayed moderate to poor flowability, and mechanical assistance was needed to facilitate powder flow through the hoppers on the tablet presses. Even with assisted flow, tablet press speeds needed to be at or near their mechanical minimums to avoid large weight variation.

### Example 5: Implementation of the Invention

Since July 2016, several batches of the Organic Men's 40 Plus Multivitamin Tablet formula have been successfully produced utilizing the final iteration of the invention.

Summary of the Process:

0.6% (by weight) of an aqueous granulating solution consisting of 18% organic gum arabic and 82% RODI water is added to the powder blend prior to the addition of the Nu-Flow® and organic pre-gelatinized potato starch in a Patterson-Kelley, liquid-solids, twin-shell V-blender using a two-disc cantilever intensifier-bar (I-bar) liquid addition assembly that comes standard with these blenders. After addition of the granulating solution, the granulated blend is sifted through a #12 screen to eliminate large agglomerates. The sifted material is added back to the blender. Nu-Flow® and organic pre-gelatinized potato starch are added to the blend. The entire blend is then sifted through a #12 screen a final time. The process has been verified in 5, 30, and 75 cu ft sized blenders.

Method:

75 Cubic Foot V-Blender

Batch Range—1129 kg to 1379 kg

Stage 1 (making the granulating solution):

1. Prepare the 18% gum arabic/82% water solution in advance of blending.

Stage 2:

1. Weigh out Orgen HIM Plus®, organic sea kelp, vitamin K1 renatured 207M, vitamin B12 renatured 207M, vitamin D3, vitamin K2, organic moringa leaf extract, organic wrightia herb extract, organic lantana herb extract, organic pomegranate juice pwd, organic tomato powder, organic turmeric powder, organic pumpkin powder, organic veggie blend, organic fruit blend, and Nu-RICE®. Sift these materials through a #20 screen and add to the blender.

2. Weigh out the beta carotene veg beadlets, pre-hydrated organic gum arabic, Tapiok® organic tapioca dextrose. Sift these materials through a #12 screen and add to the blender.

3. Mix in the v-blender for 2 minutes (I-bar off).

Stage 3:

1. Into barrels, dump the blend.

2. Sift the dumped blend through a #12 screen and add to the blender.

3. Mix in the v-blender for 5 minutes (I-bar off).

Stage 4:

1. After the 5 minutes of mixing in Stage 3, continue tumbling and add the granulating solution with the liquid addition bar on at 900 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 10 seconds with the liquid addition bar still on.

3. Turn the liquid addition bar off and continue mixing for another 2 minutes and 30 seconds.

Stage 5:

1. Immediately after mixing, dump the blend and sift through a #12 screen and add back to the blender.

2. Dump a barrel of material from the blender.

3. Into the barrel of dumped blend, weigh out the organic pre-gelatinized potato starch.

4. Sift the material from step 3 through a #20 screen two (2) times and then add to the blender. Add back to the blender any hard granules that will not easily pass through the #20 screen.

5. Jog the blender for three (3) rotations.

6. Dump a barrel of material from the blender.

7. Into the barrel of dumped blend, weigh out the Nu-Flow®.

8. Sift the material from step 7 through a #20 screen two (2) times and then add to the blender. Add back to the blender any hard granules that will not easily pass through the #20 screen.

9. Mix in the v-blender for 3 minutes and 45 seconds (bar off).

Stage 6:

1. Immediately after mixing, dump the blend and sift through a #12 screen. If possible, push overs through the screen by hand. Material that cannot be pushed through the screen by hand is to be milled until 100% of the blend passes through the #12 screen.

30 Cubic Foot V-Blender

Batch Range—452 kg to 551 kg

Stage 1 (making the granulating solution):

1. Prepare the 18% gum arabic/82% water solution in advance of blending.

Stage 2:

1. Weigh out Orgen HIM Plus®, organic sea kelp, vitamin K1 renatured 207M, vitamin B12 renatured 207M, vitamin D3, vitamin K2, organic moringa leaf extract, organic wrightia herb extract, organic lantana herb extract, organic pomegranate juice pwd, organic tomato powder, organic turmeric powder, organic pumpkin powder, organic veggie blend, organic fruit blend, and Nu-RICE®. Sift these materials through a #20 screen and add to the blender.

2. Weigh out the beta carotene veg beadlets, pre-hydrated organic gum arabic, Tapiok® organic tapioca dextrose. Sift these materials through a #12 screen and add to the blender.

3. Mix in the v-blender for 1 minute and 30 seconds (I-bar off).

Stage 3:

1. Into barrels, dump the blend.

2. Sift the dumped blend through a #12 screen and add to the blender.

3. Mix in the v-blender for 4 minutes (I-bar off).

Stage 4.

1. After the 5 minutes of mixing in Stage 3, continue tumbling and add the granulating solution with the liquid addition bar on at 700 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 10 seconds with the liquid addition bar still on.

3. Turn the liquid addition bar off and continue mixing for another 2 minutes.

Stage 5:

1. Immediately after mixing, dump the blend and sift through a #12 screen and add back to the blender.

2. Dump a barrel of material from the blender

3. Into the barrel of dumped blend, weigh out the organic pre-gelatinized potato starch.

4. Sift the material from step 3 through a #20 screen two (2) times and then add to the blender. Add back to the blender any hard granules that will not easily pass through the #20 screen.

5. Jog the blender for three (3) rotations.

6. Dump a barrel of material from the blender.

7. Into the barrel of dumped blend, weigh out the Nu-Flow®.

8. Sift the material from step 7 through a #20 screen two (2) times and then add to the blender. Add back to the blender any hard granules that will not easily pass through the #20 screen.

9. Mix in the v-blender for 3 minutes (bar off).

Stage 6:

1. Immediately after mixing, dump the blend and sift through a #12 screen. If possible, push overs through the screen by hand. Material that cannot be pushed through the screen by hand is to be milled until 100% of the blend passes through the #12 screen.

5 Cubic Foot V-Blender

Batch Range—76 kg to 91 kg

Stage 1 (making the granulating solution):

1. Prepare the 18% gum arabic/82% water solution in advance of blending.

Stage 2:

1. Weigh out Orgen HIM Plus®, organic sea kelp, vitamin K1 renatured 207M, vitamin B12 renatured 207M, vitamin D3, vitamin K2, organic moringa leaf extract, organic wrightia herb extract, organic lantana herb extract, organic pomegranate juice pwd, organic tomato powder, organic turmeric powder, organic pumpkin powder, organic veggie blend, organic fruit blend, and Nu-RICE®. Sift these materials through a #20 screen and add to the blender.

2. Weigh out the beta carotene veg beadlets, pre-hydrated organic gum arabic, Tapiok® organic tapioca dextrose. Sift these materials through a #12 screen and add to the blender.

3. Mix in the v-blender for 1 minute (I-bar off).

Stage 3:

1. Into barrels, dump the blend.

2. Sift the dumped blend through a #12 screen and add to the blender.

3. Mix in the v-blender for 3 minutes (I-bar off).

Stage 4:

1. After the 5 minutes of mixing in Stage 3, continue tumbling and add the granulating solution with the liquid addition bar on at 225 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 10 seconds with the liquid addition bar still on.

3. Turn the liquid addition bar off and continue mixing for another 1 minute and 30 seconds.

Stage 5:

1. Immediately after mixing, dump the blend and sift through a #12 screen and add back to the blender.

2. Dump a barrel of material from the blender

3. Into the barrel of dumped blend, weigh out the organic pre-gelatinized potato starch.

4. Sift the material from step 3 through a #20 screen two (2) times and then add to the blender. Add back to the blender any hard granules that will not easily pass through the #20 screen.

5. Jog the blender for three (3) rotations.

6. Dump a barrel of material from the blender.

7. Into the barrel of dumped blend, weigh out the Nu-Flow®.

8. Sift the material from step 7 through a #20 screen two (2) times and then add to the blender. Add back to the blender any hard granules that will not easily pass through the #20 screen.

9. Mix in the v-blender for 2 minutes and 30 seconds (bar off).

Stage 6

1. Immediately after mixing, dump the blend and sift through a #12 screen. If possible, push overs through the screen by hand. Material that cannot be pushed through the screen by hand is to be milled until 100% of the blend passes through the #12 screen.

Results:

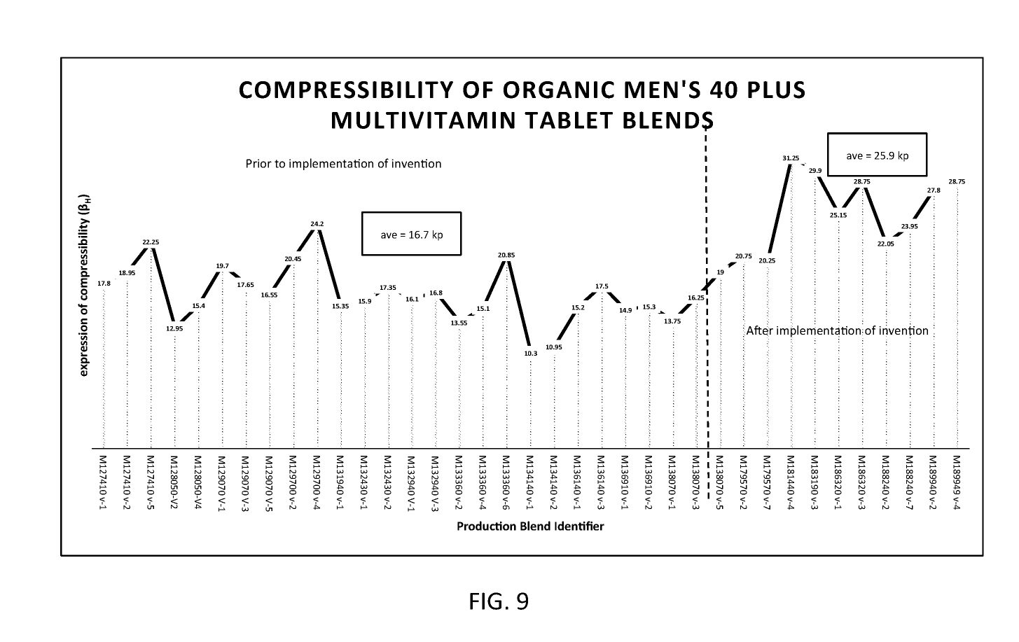

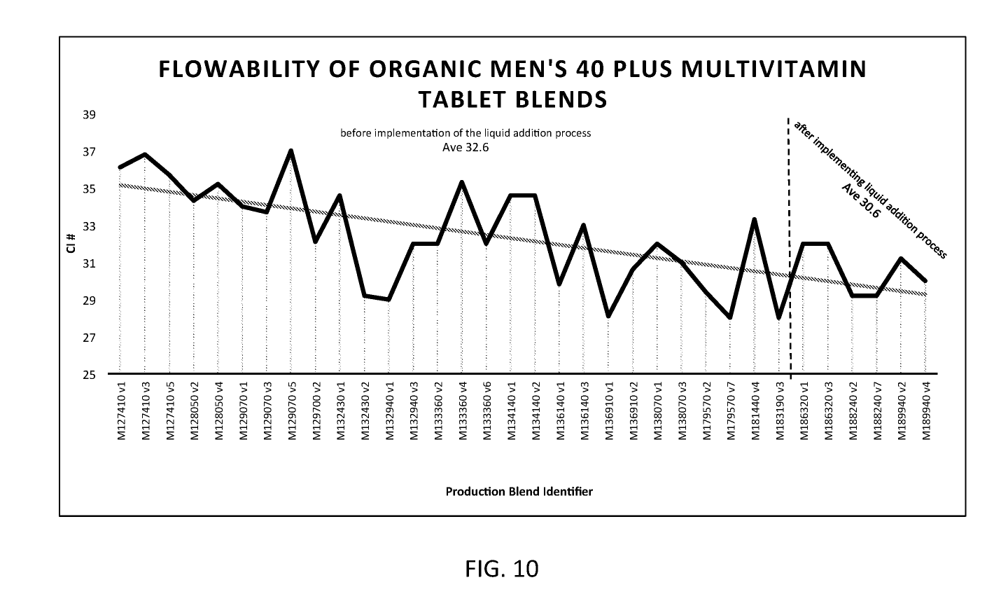

Six batches of Organic Men's 40 Plus Multivitamin Tablet have been successfully produced utilizing the invention through April, 2017. FIGS. 9 and 10 show significant improvement to compressibility and flowability, respectively.

Prior to the invention, the average compressibility of production blends of Organic Men's 40 Plus Multivitamin Tablet was 16.7 kp. After employing the invention, the average compressibility of production blends of this same formula was 25.9 kp, an improvement of ˜55%.

Prior to the invention, the average flowability of production blends of Organic Women's Multivitamin Tablet was 32.6. After employing the invention, the average flowability of production blends of this same formula was 30.6, an improvement of ˜6%.

### Conclusion

Two case studies have been presented that demonstrate the invention of a process that overcomes many of the hurdles encountered when making 95% organic tablets for the Dietary Supplement Industry. The process involves introduction of a 0.6-1.0% w/w granulating solution consisting of 18% organic gum arabic (acacia gum) and 82% water into a dry powder blend. The granulating solution is added to the powder by using an intensifier-bar liquid addition assembly that comes with a Patterson-Kelley liquids/solids twin shell v-blender. Compressibility and flowability of the powder blends improved upon utilization of the invention.

### Example 6: Immune System Boost Chewable Formula

This study involves an Immune System Boost Chewable Tablet. This formula is comprised of an extremely high load of active materials, including 575 mg/tablet of a Strawberry/Raspberry Powder blend and 155 mg/tablet of a mushroom powder blend. These materials have extremely poor compressibility and are very difficult to compress into to a tablet.

The majority of active raw materials in this formula are poorly compressible herbal powders. The total weight of active materials in the tablet is over 1200 mg. There is little room for dilution of the formula with effective binders. Additionally, this is a chewable tablet, which limits the types of binders that can be used to sugars and sugar alcohols in order to provide acceptable flavor and sweetness. Sugars and sugar alcohols are moderately effective at providing the structure and binding capacity required to make an acceptable tablet.

The formula described below, without implementation of the liquid addition process, was difficult to manufacture. Extremely slow press speeds and pre-compression were typically required to avoid quality issues; primarily capping and high friability.

TABLE 7
Immune System Boost Chewable Tablet Full Formula.

| | | | % of |
|---|---|---|---|
| Ingredient | Supplier | mg/tablet | formula |
| Strawberry Powder Drum Dried | Futureceuticals | 475.000 | 25.68% |
| Raspberry Spray Dried Powder | Futureceuticals | 100.000 | 5.41% |
| Goji Powder Spray Dried | Futureceuticals | 150.000 | 8.11% |
| REISHI MUSHROOM POWDER | Ministar | 60.000 | 3.24% |
| Maitake Mushroom Powder | M2 Ingredients | 55.000 | 2.97% |
| Agaricus Blazei Mushroom Pwd | M2 Ingredients | 40.000 | 2.16% |
| Arabinogalactan-Fiber Aid | Lonza | 45.000 | 2.43% |
| SELENIUM AAC | Albion | 6.936 | 0.37% |
| COPPER GLYCINATE | Albion | 1.632 | 0.09% |
| CHELATE | | | |
| ZINC GLYCINATE CHELATE | Albion | 25.500 | 1.38% |
| CALCIUM CARBONATE | Erie Foods | 238.000 | 12.86% |
| GRAN DC | | | |
| MELATONIN | Maypro | 4.192 | 0.23% |
| Orange Essential Oil Powder | NPRI | 15.000 | 0.81% |
| ORGANIC STEVIA BLEND | Pyure | 34.500 | 1.86% |
| SWEETENER | | | |
| HYDROXYPROPYL- | Ashland | 50.000 | 2.70% |
| CELLULOSE HPC | | | |
| DEXTROSE NON GMO- | JRS Pharma | 521.990 | 28.22% |
| Cantab ® | | | |
| SILICON DIOXIDE- | Grace | 17.250 | 0.93% |
| Syloid ® 244 | | | |
| MAGNESIUM STEARATE | Sun ACE | 10.000 | 0.54% |
| | sum | 1,850.000 | |

Each individual raw material was screened and the dry powder blends mixed using twin-shell v-blenders consistent with typical direct compression manufacturing processes.

This formula was compressed into tablets using 0.6250 inch round D tooling (Natoli HOB #91600) on a variety of tablet presses, including 8-ton Manesty Mark II tablet presses with and without pre-compression and a Manesty D3 16 station press without pre-compression. The formula was also pressed using B Tooling (Natoli HOB #91600) on a 35 station Stokes Press both with and without pre-compression.

Several million tablets of the Immune System Boost Chewable Tablet formula referenced above were produced between the Fall 2015 and the Spring of 2017. During this ˜two-year period, production experienced inconsistent run-ability of this product on the tablet presses which resulted in product quality issues. Poor compressibility of the blend often led to manufacturing defects such as capping, high friability, broken/soft tablets, and low production yields.

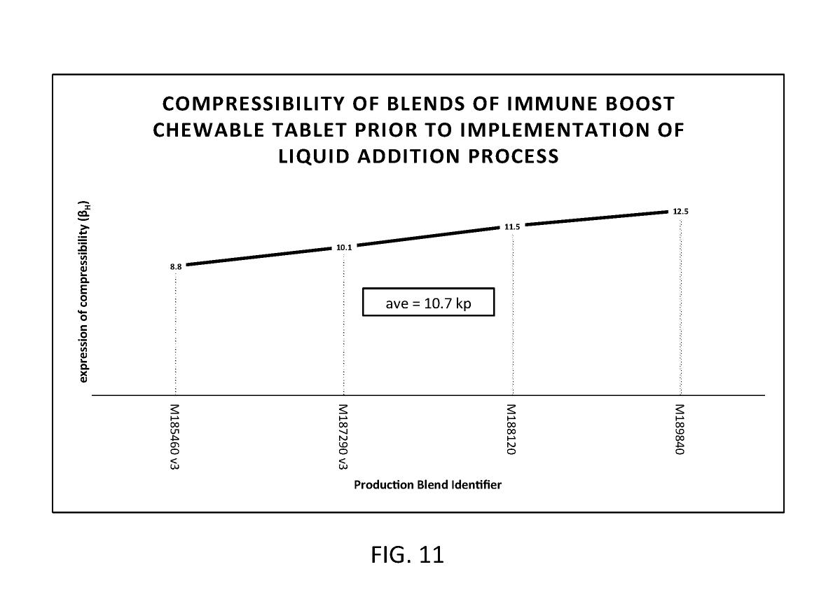

FIG. 11 shows the compressibility of production blends from Fall of 2014 to Spring of 2017, prior to implementation of the invention. For this paper, compressibility is defined as the relationship between breaking strength (hardness) and compaction pressure. Compressibility of each blend was measured by first filling a 0.6250 inch round die with powder equal to the fill weight of the tablet (˜1850 mg). Then, the powder was compressed into tablets using 0.6250 inch round tooling via a Carver Press, model M. Tablets were compressed at progressively increasing applied pressure (psi), then measured for hardness (kp) using a Varian VK200 tablet hardness tester. For ease of interpretation, the data is shown in FIG. 11 as a simple and novel expression of compressibility, β_{H}. β_{H} is the average hardness of tablets compressed at 800 PSI and 1000 PSI for each blend tested.

Blends made during Fall 2015 to Spring 2017 had poor compressibility (note: there is no data from several blends, but data shown here represent the entire time period). The average of this expression of compressibility (β_{H}) over this time is 10.7.

### Example 7: Implementation of the Invention

Two batches of Immune System Boost Chewable formula have been successfully produced utilizing the invention in mid-2017 (M193410 and M196290)

Summary of the Process:

1.0% (by weight) of an aqueous granulating solution consisting of 7% Hydroxypropylcellulose (HPC) and 93% RODI water is added to the powder blend prior to the addition of the Melatonin, Orange Essential Oil Powder, Silicon Dioxide, and Magnesium Stearate in a Patterson-Kelley, liquid-solids, twin-shell V-blender using a two-disc cantilever intensifier-bar (I-bar) liquid addition assembly that comes standard with these blenders. After addition of the granulating solution, the granulated blend is sifted through a #12 screen to eliminate large agglomerates. The sifted material is added back to the blender. Melatonin, Orange Essential Oil Powder, Silicon Dioxide are added to the blend, and the blend is tumbled in the blender (time determined by the size of the blender). Magnesium Stearate is then added as the final ingredient and the blend is tumbled again (time determined by the size of the blender). The entire blend is then sifted through a #12 screen a final time. The process has been verified for the 30 cu ft v-blender, but should be directly scalable to other Patterson-Kelley twin-shell v-blender sizes.

Method:

75 Cubic Foot V-Blender

Batch Range—1138 kg to 1390 kg

Stage 1 (making the granulating solution):

1. Prepare the 7% HPC/93% water solution in advance of blending.

Stage 2:

1. Weigh out Dextrose non-GMO Cantab®, Strawberry Powder Drum Dried, and

Raspberry Spray Dried Powder. Sift these materials through a #12 screen and add to the blender.

2. Weigh out Goji Powder Spray Dried, Reishi Mushroom Powder, Maitake Mushroom Powder, ˜⅓ of the Silicon Dioxide, Agaricus Blazei Mushroom Pwd, Arbinogalactan, Hydroxyproplycellulose, Selenium Aac, Copper Glycinate Chelate, Zinc Glycinate Chelate. Sift these materials through a #20 screen and add to the blender.

3. Weigh out the Calcium Carbonate Gran DC. Sift this material through a #12 screen and add to the blender.

4. Mix in the v-blender for 5 minutes (I-bar off).

Stage 3:

1. After the 5 minutes of mixing in Stage 2, continue tumbling and add the granulating solution with the liquid addition bar on at 1000 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 30 seconds with the liquid addition bar still on.

3. Turn the liquid addition bar off and continue mixing for another 2 minutes and 30 seconds.

Stage 4:

1. Immediately after mixing, dump the blend and sift through a #12 screen and add back to the blender. Material that cannot be pushed through the screen by hand is to be milled until 100% of the blend passes through the #12 screen.

2. Dump a barrel of material from the blender.

3. Into the barrel of dumped blend, weigh out the Melatonin, Orange Essential Oil Powder, and the rest of the Silicon Dioxide.

4. Sift the material from step 3 through a #20 screen two (2) times and then add to the blender. Add back to the blender any hard granules that will not easily pass through the #20 screen.

5. Mix in the v-blender for 7 minutes and 30 seconds (bar off).

Stage 5:

1. Dump a barrel of material from the blender.

2. Into the barrel of dumped blend, weigh out the Magnesium Stearate.

3. Sift the material from step 2 through a #20 screen two (2) times and then add to the blender. Add back to the blender any hard granules that will not easily pass through the #20 screen

4. Mix in the v-blender for 2 minutes and 30 seconds (bar off).

Stage 6:

1. Immediately after mixing, dump the blend and sift through a #12 screen. If possible, push overs through the screen by hand. Material that cannot be pushed through the screen by hand is to be milled until 100% of the blend passes through the #12 screen.

30 Cubic Foot V-Blender

Batch Range—455 kg to 556 kg

Stage 1 (making the granulating solution):

1. Prepare the 7% HPC/93% water solution in advance of blending.

Stage 2:

1. Weigh out Dextrose non-GMO Cantab®, Strawberry Powder Drum Dried, and

Raspberry Spray Dried Powder. Sift these materials through a #12 screen and add to the blender.

2. Weigh out Goji Powder Spray Dried, Reishi Mushroom Powder, Maitake Mushroom Powder, ˜⅓ of the Silicon Dioxide, Agaricus Blazei Mushroom Pwd, Arbinogalactan, Hydroxyproplycellulose, Selenium Aac, Copper Glycinate Chelate, Zinc Glycinate Chelate. Sift these materials through a #20 screen and add to the blender.

3. Weigh out the Calcium Carbonate Gran DC. Sift this material through a #12 screen and add to the blender.

4. Mix in the v-blender for 4 minutes (I-bar off).

Stage 3:

1. After the 4 minutes of mixing in Stage 2, continue tumbling and add the granulating solution with the liquid addition bar on at 1000 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 30 seconds with the liquid addition bar still on.

3. Turn the liquid addition bar off and continue mixing for another 2 minutes.

Stage 4:

1. Immediately after mixing, dump the blend and sift through a #12 screen and add back to the blender. Material that cannot be pushed through the screen by hand is to be milled until 100% of the blend passes through the #12 screen.

2. Dump a barrel of material from the blender.

3. Into the barrel of dumped blend, weigh out the Melatonin, Orange Essential Oil Powder, and the rest of the Silicon Dioxide.

4. Sift the material from step 3 through a #20 screen two (2) times and then add to the blender. Add back to the blender any hard granules that will not easily pass through the #20 screen.

5. Mix in the v-blender for 6 minutes (bar off).

Stage 5:

1. Dump a barrel of material from the blender.

2. Into the barrel of dumped blend, weigh out the Magnesium Stearate.

3. Sift the material from step 2 through a #20 screen two (2) times and then add to the blender. Add back to the blender any hard granules that will not easily pass through the #20 screen

4. Mix in the v-blender for 2 minutes (bar off).

Stage 6:

1. Immediately after mixing, dump the blend and sift through a #12 screen. If possible, push overs through the screen by hand. Material that cannot be pushed through the screen by hand is to be milled until 100% of the blend passes through the #12 screen.

5 Cubic Foot V-Blender

Batch Range—76 kg to 92 kg

Stage 1 (making the granulating solution):

1. Prepare the 7% HPC/93% water solution in advance of blending.

Stage 2:

1. Weigh out Dextrose non-GMO Cantab®, Strawberry Powder Drum Dried, and Raspberry Spray Dried Powder. Sift these materials through a #12 screen and add to the blender.

2. Weigh out Goji Powder Spray Dried, Reishi Mushroom Powder, Maitake Mushroom Powder, ˜⅓ of the Silicon Dioxide, Agaricus Blazei Mushroom Pwd, Arbinogalactan, Hydroxyproplycellulose, Selenium Aac, Copper Glycinate Chelate, Zinc Glycinate Chelate. Sift these materials through a #20 screen and add to the blender.

3. Weigh out the Calcium Carbonate Gran DC. Sift this material through a #12 screen and add to the blender.

4. Mix in the v-blender for 3 minutes (I-bar off).

Stage 3:

1. After the 3 minutes of mixing in Stage 2, continue tumbling and add the granulating solution with the liquid addition bar on at 1000 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 30 seconds with the liquid addition bar still on.

3. Turn the liquid addition bar off and continue mixing for another 1 minute and 30 seconds.

Stage 4:

1. Immediately after mixing, dump the blend and sift through a #12 screen and add back to the blender. Material that cannot be pushed through the screen by hand is to be milled until 100% of the blend passes through the #12 screen.

2. Dump a barrel of material from the blender.

3. Into the barrel of dumped blend, weigh out the Melatonin, Orange Essential Oil Powder, and the rest of the Silicon Dioxide.

4. Sift the material from step 3 through a #20 screen two (2) times and then add to the blender. Add back to the blender any hard granules that will not easily pass through the #20 screen.

5. Mix in the v-blender for 4 minutes and 30 seconds (bar off).

Stage 5:

1. Dump a barrel of material from the blender.

2. Into the barrel of dumped blend, weigh out the Magnesium Stearate.

3. Sift the material from step 2 through a #20 screen two (2) times and then add to the blender. Add back to the blender any hard granules that will not easily pass through the #20 screen

4. Mix in the v-blender for 1 minutes and 30 seconds (bar off).

Stage 6:

1. Immediately after mixing, dump the blend and sift through a #12 screen. If possible, push overs through the screen by hand. Material that cannot be pushed through the screen by hand is to be milled until 100% of the blend passes through the #12 screen.

Results:

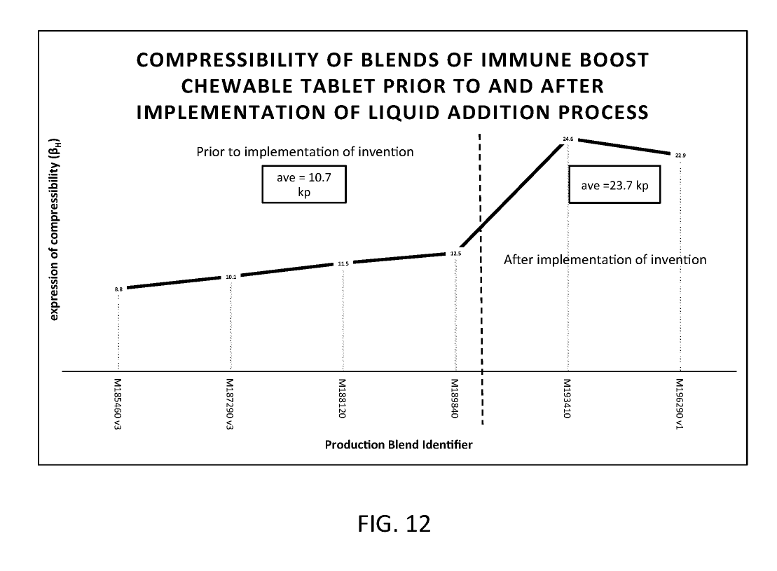

Two batches of Immune Boost Chewable Tablet have been successfully produced utilizing the invention in mid-2017. FIG. 12 shows significant improvement to compressibility of the formula.

Prior to the invention, the average compressibility (β_{H}) of production blends of Immune Boost Chewable Tablet was 10.7 kp. After employing the invention, the average compressibility of production blends of this same formula was 23.7 kp, an improvement of ˜122%.

### Example 8: Testosterone Boosting Tablet Formula

This study involves a Testosterone Boosting Tablet. This formula is comprised of an extremely high load of active materials, including 833.333 mg/tablet granulated D Aspartic Acid and 590 mg/tablet of an herbal blend comprised of Funugreek Seed Extract, Epimedium Powder, Mucuna Pruriens Extract, maca Root Powder, Nettle Root Powder and Long Jack (Tongkat Ali Root) Extract. These materials have extremely poor compressibility and are very difficult to compress into to a tablet.

During product development, it was identified that this formula had little fill room for the addition of traditional binders like microcrystalline cellulose. Additionally, the customer had a strict thickness specification of NMT 0.3300 inch, which also limited our ability to add binders to the tablet to allow for proper compression.

The formula described below has utilized the liquid addition process invention since inception.

TABLE 8
Testosterone Boosting Tablet Tablet Full Formula

| | | | % of |
|---|---|---|---|
| Ingredient | Supplier | mg/tablet | formula |
| Fenugreek Seed Extract | Jiaherb | 175.000 | 10.61% |
| BORON CITRATE | Pharmachem | 50.000 | 3.03% |
| Epimedium Powder | Jiaherb | 162.500 | 9.85% |
| Mucuna Pruriens Extract | Maypro | 62.500 | 3.79% |
| MACA ROOT POWDER | Jiaherb | 62.500 | 3.79% |
| Nettle Root Powder | FCC Products, Inc. | 90.000 | 5.45% |
| Long Jack Extract | Naturex | 37.500 | 2.27% |
| D Aspartic Acid Granulated | Pharmachem | 833.333 | 50.51% |
| DICALCIUM PHOSPHATE | Budenheim | 81.667 | 4.95% |
| ANHYD DC | | | |
| HYDROXYPROPYL- | Ashland | 44.000 | 2.67% |
| CELLULOSE HPC | | | |
| CROSCARMELLOSE | Blanver | 17.500 | 1.06% |
| SODIUM | | | |
| SILICON DIOXIDE | Grace | 9.000 | 0.55% |
| STEARIC ACID | HESEGO Industry | 17.000 | 1.03% |
| MAGNESIUM STEARATE | Sun ACE | 7.500 | 0.45% |
| VEGETABL | | | |
| | sum | 1,650.000 | |

### Example 9: Implementation of the Invention

Starting in March of 2017, 10 batches (several million tablets) of the Testosterone Boosting Tablet formula have been successfully produced utilizing the invention.

This formula was compressed into tablets using 0.8750×0.3750 inch modified elongated D tooling (Natoli HOB #70070) using an 8-ton Manesty Mark II tablet presses without pre-compression.

Summary of the Process:

˜1.8% (by weight) of an aqueous granulating solution consisting of 7% Hydroxypropylcellulose (HPC) and 93% RODI water is added to the powder blend prior to the addition of the Croscarmellose Sodium, Silicon Dioxide, Stearic Acid, and Magnesium Stearate in a Patterson-Kelley, liquid-solids, twin-shell V-blender using a two-disc cantilever intensifier-bar (I-bar) liquid addition assembly that comes standard with these blenders. After addition of the granulating solution, the granulated blend is sifted through a #12 screen to eliminate large agglomerates. The sifted material is added back to the blender. Croscarmellose Sodium, Silicon Dioxide, Stearic Acid are added to the blend, and the blend is tumbled in the blender (time determined by the size of the blender). Magnesium Stearate is then added as the final ingredient and the blend is tumbled again (time determined by the size of the blender). The entire blend is then sifted through a #12 screen a final time. The process has been verified for the 75 and 30 cu ft v-blenders, but should be directly scalable to other Patterson-Kelley twin-shell v-blender sizes.

Method:

75 Cubic Foot V-Blender

Batch Range—1118 kg to 1300 kg

Stage 1 (making the granulating solution):

1. Prepare the 7% HPC/93% water solution in advance of blending.

Stage 2:

1. Weigh out Dicalcium Phosphate Anhydrous DC, Fenugreek Seed Extract, Boron Citrate, Epimedium Powder, Mucuna Pruriens Extract, Hydroxypropylcellulose, Maca Root Powder, Nettle Root Powder, and Long Jack Extract. Sift these materials through a #20 screen and add to the blender.

2. Weigh out D Aspartic Acid Granular. Sift these materials through a #12 screen and add to the blender.

3. Mix in the v-blender for 5 minutes (I-bar off).

Stage 3:

1. After the 5 minutes of mixing in Stage 2, continue tumbling and add the granulating solution with the liquid addition bar on at 1000 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 30 seconds with the liquid addition bar still on.

3. Turn the liquid addition bar off and continue mixing for another 2 minutes and 30 seconds.

Stage 4:

1. Immediately after mixing, dump the blend and sift through a #12 screen and add back to the blender. Material that cannot be pushed through the screen by hand is to be milled until 100% of the blend passes through the #12 screen.

2. Sift and weigh the Croscarmellose Sodium and add to the blender.

3. Mix in the v-blender for 5 minutes (bar off).

Stage 5:

1. Dump a barrel of material from the blender.

2. Into the barrel of dumped blend, weigh out the Silicon Dioxide.

3. Sift the material from step 2 through a #20 screen two (2) times and then add to the blender. Add back to the blender any hard granules that will not easily pass through the #20 screen.

4. Jog the blender for three (3) rotations.

5. Dump a barrel of material from the blender.

6. Into the barrel of dumped blend, weigh out the Stearic Acid.

7. Sift the material from step 6 through a #20 screen two (2) times and then add to the blender. Add back to the blender any hard granules that will not easily pass through the #20 screen.

8. Mix in the v-blender for 3 minutes and 45 seconds (bar off).

Stage 6:

1. Dump a barrel of material from the blender.

2. Into the barrel of dumped blend, weigh out the Magnesium Stearate.

3. Sift the material from step 2 through a #20 screen two (2) times and then add to the blender. Add back to the blender any hard granules that will not easily pass through the #20 screen.

4. Mix in the v-blender for 2 minutes and 30 seconds (bar off).

Stage 7:

1. Immediately after mixing, dump the blend and sift through a #12 screen. If possible, push overs through the screen by hand. Material that cannot be pushed through the screen by hand is to be milled until 100% of the blend passes through the #12 screen.

30 Cubic Foot V-Blender

Batch Range—447 kg to 520 kg

Stage 1 (making the granulating solution):

1. Prepare the 7% HPC/93% water solution in advance of blending.

Stage 2:

1. Weigh out Dicalcium Phosphate Anhydrous DC, Fenugreek Seed Extract, Boron Citrate, Epimedium Powder, Mucuna Pruriens Extract, Hydroxypropylcellulose, Maca Root Powder, Nettle Root Powder, and Long Jack Extract. Sift these materials through a #20 screen and add to the blender.

2. Weigh out D Aspartic Acid Granular. Sift these materials through a #12 screen and add to the blender.

3. Mix in the v-blender for 4 minutes (I-bar off).

Stage 3:

1. After the 4 minutes of mixing in Stage 2, continue tumbling and add the granulating solution with the liquid addition bar on at 1000 mL/min using a Masterflex I/P digital modular drive controller (model 7592-82), a Masterflex 20-650 rpm I/P pump drive (model 7592-40) connected to a Masterflex Easy Load I/P pump head (model 77601-10), and Masterflex 06508-26 pharma grade tubing.

2. Once finished, use compressed air to flush the system for 30 seconds with the liquid addition bar still on.

3. Turn the liquid addition bar off and continue mixing for another 2 minutes.

Stage 4:

1. Immediately after mixing, dump the blend and sift through a #12 screen and add back to the blender. Material that cannot be pushed through the screen by hand is to be milled until 100% of the blend passes through the #12 screen.

2. Sift and weigh the Croscarmellose Sodium and add to the blender.

3. Mix in the v-blender for 4 minutes (bar off).

Stage 5:

1. Dump a barrel of material from the blender.

2. Into the barrel of dumped blend, weigh out the Silicon Dioxide.

3. Sift the material from step 2 through a #20 screen two (2) times and then add to the blender. Add back to the blender any hard granules that will not easily pass through the #20 screen.

4. Jog the blender for three (3) rotations.

5. Dump a barrel of material from the blender.

6. Into the barrel of dumped blend, weigh out the Stearic Acid.

7. Sift the material from step 6 through a #20 screen two (2) times and then add to the blender. Add back to the blender any hard granules that will not easily pass through the #20 screen.

8. Mix in the v-blender for 3 minutes (bar off).

Stage 6:

1. Dump a barrel of material from the blender.

2. Into the barrel of dumped blend, weigh out the Magnesium Stearate.

3. Sift the material from step 2 through a #20 screen two (2) times and then add to the blender. Add back to the blender any hard granules that will not easily pass through the #20 screen

4. Mix in the v-blender for 2 minutes (bar off).

Stage 7:

1. Immediately after mixing, dump the blend and sift through a #12 screen. If possible, push overs through the screen by hand. Material that cannot be pushed through the screen by hand is to be milled until 100% of the blend passes through the #12 screen.

Results:

Starting in March of 2017, 10 batches (several million tablets) of the Testosterone Boosting Tablet formula have been successfully produced utilizing the invention.

This formula was compressed into tablets using 0.8750×0.3750 inch modified elongated D tooling (Natoli HOB #70070) using an 8-ton Manesty Mark II tablet presses without pre-compression.

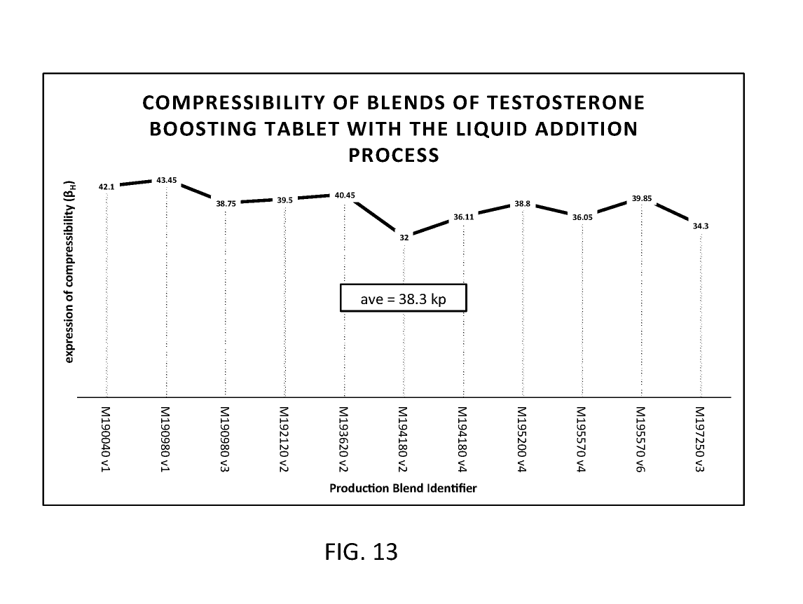

FIG. 13 shows compressibility results for the batches tested. As can be seen, blends of Testosterone Boosting Tablet formula had exceptional compressibility, which allowed us to produce tablets of high quality (high hardness/low friability) at high press speeds. In an embodiment, the Testosterone Boosting Tablet, as shown in FIG. 13, has a compressibility of about 38.3 kp, which is a significant improvement over other tablets of comparable size and shape.

### Conclusion

Two case studies have been presented that demonstrate the invention of a process that overcomes problems associated with poor blend compressibility for tablet powder blends with high loads of herbal powders for the Dietary Supplement Industry. The process involves introduction of between about 1.0% and about 2% w/w granulating solution consisting of 7% Hydroxypropylcellulose (HPC) and 93% water by using an intensifier-bar liquid addition assembly that comes with a Patterson-Kelley liquids/solids twin shell v-blender.

The invention was shown to be effective when applied to two (2) disparate tablet formulas and tablet size/shapes. For the 0.6250″ round Immune Boosting Tablet, the invention was applied to a formula with a water soluble, sugar-based matrix. For the 0.8750×0.3750″ oval Testosterone Boosting Tablet, the invention was applied to a traditional Microcrystalline Cellulose/Dicalcium Phosphate matrix.

Compressibility and tablet quality for both formulas either improved (in the case of the Immune Boosting Tablet) or were shown to be exceptional since product inception (in the case of the Testosterone Boosting Tablet) upon utilization of the invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims and list of embodiments disclosed herein. Although specific terms are employed herein, they are used in a generic and descriptive sense only and not for purposes of limitation.

What is claimed is:

1. A method of manufacturing an organic dietary supplement, comprising adding an aqueous granulating solution to an organic dietary supplement formulation to improve compressibility of the supplement, wherein the aqueous granulating solution comprises organic gum arabic.

2. The method of claim 1, wherein the concentration of organic gum arabic in the aqueous granulating solution is from about 5% to about 30% by weight.

3. The method of claim 1, wherein the concentration of organic gum arabic in the aqueous granulating solution is about 18% by weight.

4. The method of claim 1, wherein the aqueous granulating solution further comprises RODI water.

5. The method of claim 4, wherein the concentration of RODI water in the aqueous granulating solution is from about 70% to about 95% by weight.

6. The method of claim 5, wherein the concentration of RODI water in the aqueous granulating solution is about 82% by weight.

7. The method of claim 1, wherein the aqueous granulating solution comprises less than or about 2.0%, 1.5%, 1.0%, 0.9%, 0.80%, 0.75%, 0.70%, 0.65%, 0.6% or 0.5% by weight of the formulation.

8. The method of claim 1, wherein the formulation is selected from the group consisting of active ingredients, binders, anti-caking agents, lubricants, and disintegrants.

9. The method of claim 8, wherein the active ingredient is selected from the group consisting of vitamins, minerals, herbs, or other botanicals, essential amino acids, essential fatty acids, dietary substances, and combinations thereof.

10. The method of claim 8, wherein the binder is prehydrated organic gum arabic.

11. The method of claim 10, wherein the binder is included in an amount between about 2.5 wt % and about 8.0 wt % of the formulation.

12. The method of claim 10, wherein the binder is included in an amount of about 3.75 wt % of the formulation.

13. The method of claim 8, wherein the anti-caking agent is selected from the group consisting of an organic corn starch and organic rice concentrate.

14. The method of claim 13, wherein the anti-caking agent is an organic rice concentrate.

15. The method of claim 13, wherein the anti-caking agent is included in an amount between about 0.5 wt % and about 3.0 wt % of the formulation.

16. The method of claim 9, wherein the disintegrant is selected from the group consisting of pre-gelatinized potato starch, pre-gelatinized maize starch, and pre-gelatinized tapioca starch.

17. The method of claim 16, wherein the disintegrant is a pre-gelatinized potato starch.

18. The method of claim 16, wherein the disintegrant is included in an amount between about 1.0 wt % and about 3.0 wt % of the formulation.

19. The method of claim 8, wherein the lubricant is selected from the group consisting of Nu-Mag®, coconut oil powder, and an organic rice extract.

20. The method of claim 19, wherein the lubricant is an organic rice extract.

21. The method of claim 19, wherein the lubricant is included in an amount between about 0.5 wt % and about 3.0 wt % of the formulation.

22. The method of claim 8, wherein the glidant is selected from the group consisting of organic maltodextrin (corn or rice), organic grape dextrose, and organic tapioca dextrose.

23. The method of claim 22, wherein the glidant is organic tapioca dextrose.

24. The method of claim 22, wherein the glidant is included in an amount between about 40.0 wt % and about 50.0 wt % of the formulation.

25. The method of claim 1, wherein compressibility of the supplement is between about 24 kp and about 34 kp.

26. The method of claim 1, wherein compressibility of the supplement is about 27.8 kp.

27. The method of claim 1, wherein compressibility of the supplement is increased by at least 40% when compared to traditional methods.

28. The method of claim 1, wherein flowability of the supplement is between about 25.00 C and about 35.0 C.

29. The method of claim 1, wherein flowability of the supplement is about 31.82 C.

30. The method of claim 1, wherein flowability of the supplement is increased by at least 10% when compared to traditional methods.

31. A process of preparing an organic dietary supplement comprising:
(A) preparing an aqueous granulating solution by dissolving about 0.18% weight of the total composition of gum arabic in an acceptable solvent or water;
(B) adding the aqueous granulating solution of Step A to a dry blend of ingredients, and forming a granulate;
(C) blending the granulate from Step B with a disintegrant, a binder, a glidant, a lubricant, and an anti-caking agent; and
(D) compressing the final granulation from step C into a tablet.

32. The process of claim 31 wherein:
in Step A the aqueous granulating solution comprises less than or equal to less than or about 2.0%, 1.5%, 1.0%, 0.9%, 0.80%, 0.75%, 0.70%, 0.65%, 0.6% or 0.5% by weight of the formulation;
in Step B the dry blend of ingredients include active ingredients active ingredient selected from the group consisting of vitamins, minerals, herbs, or other botanicals, essential amino acids, essential fatty acids, dietary substances, and combinations thereof; and
in Step C the disintegrant used in an organic pregelatinized potato starch, the binder used is prehydrated organic gum arabic, the glidant used is organic tapioca dextrose, the lubricant used is an organic rice extract, and the anti-caking agent used is an organic rice concentrate.

33. The process of 31, wherein the specific ingredients and amounts used are:

| Ingredient | Supplier | mg/tablet |
|---|---|---|
| Orgen Him Plus ® | Orgenetics, Inc. | 525.000 |
| ORGANIC MORINGA LEAF | Orgenetics, Inc. | 1.000 |
| EXTRACT | | |
| ORGANIC WRIGHTIA HERB | Orgenetics, Inc. | 1.000 |
| EXTRACT | | |
| ORGANIC LANTANA HERB | Orgenetics, Inc. | 1.000 |
| EXTRACT | | |
| ORGANIC CURRY LEAVES | Orgenetics, Inc. | 55.556 |
| EXTRACT | | |
| VITAMIN K1 RENATURED | Grow Company, Inc. | 9.000 |
| VITAMIN B12 RENATURED 207M | Grow Company, Inc. | 2.640 |
| VITAMIN D3 | Grow Company, Inc. | 13.000 |
| VITAMIN K2 | Grow Company, Inc. | 0.462 |
| ORGANIC VEGGIE BLEND | Futureceuticals | 25.000 |
| ORGANIC FRUIT BLEND | Futureceuticals | 25.000 |
| BETA CAROTENE VEG | Lycored Bio, Ltd. | 16.538 |
| BEADLETS | | |
| ORGANIC PREGELATINIZED | Marroquin Organic | 29.500 |
| POTATO STARCH | International, Inc. | |
| PREHYDRATED ORGANIC | TiC Gums | 59.000 |
| GUM ARABIC | | |
| TapiOK ® ORGANIC | Ciranda | 682.340 |
| TAPIOCA DEXTROSE | | |
| ORGANIC RICE EXTRACT | Ribus, Inc. | 29.500 |
| (Nu-RICE ®) | | |
| ORGANIC RICE CONCENTRATE | Ribus, Inc. | 14.750 |
| (Nu-Flow ®) | | |
| | total mg | 1,490.286 |

34. A method of improving compressibility of an organic dietary supplement, comprising adding an aqueous granulating solution to an organic dietary supplement formulation at beginning of manufacturing, wherein the aqueous granulating solution comprises organic gum arabic.

35. A method of improving flowability of an organic dietary supplement, comprising adding an aqueous granulating solution to an organic dietary supplement formulation at beginning of manufacturing, wherein the aqueous granulating solution comprises organic gum arabic.

36. A method of manufacturing a non-organic dietary supplement, comprising adding an aqueous granulating solution to the non-organic dietary supplement formulation to improve compressibility of the supplement, wherein the aqueous granulating solution comprises hydroxypropylcellulose (HPC).

37. The method of claim 36, wherein the concentration of HPC in the aqueous granulating solution is about 7% by weight.

38. The method of claim 36, wherein the aqueous granulating solution further comprises RODI water.

39. The method of claim 38, wherein the concentration of RODI water in the aqueous granulating solution is about 93% by weight.

40. The method of claim 36, wherein the aqueous granulating solution comprises less than or about 2.0%, 1.5%, 1.0%, 0.9%, 0.80%, 0.75%, 0.70%, 0.65%, 0.6% or 0.5% by weight of the formulation.

41. The method of claim 36, wherein the formulation is selected from the group consisting of active ingredients, binders, anti-caking agents, lubricants, and disintegrants.

42. The method of claim 41, wherein the active ingredient is selected from the group consisting of vitamins, minerals, herbs, or other botanicals, essential amino acids, essential fatty acids, dietary substances, and combinations thereof.

43. The method of claim 41, wherein the binder is HPC.

44. The method of claim 41, wherein the binder is included in an amount between about 2.5 wt % and about 8.0 wt % of the formulation.

45. The method of claim 41, wherein the anti-caking agent is silicon dioxide.

46. The method of claim 45, wherein the anti-caking agent is included in an amount between about 0.5 wt % and about 3.0 wt % of the formulation.

47. The method of claim 41, wherein the disintegrant is croscarmellose sodium.

48. The method of claim 41, wherein the disintegrant is included in an amount between about 1.0 wt % and about 3.0 wt % of the formulation.

49. The method of claim 41, wherein the lubricant is selected from the group consisting of stearic acid and magnesium stearate.

50. The method of claim 41, wherein the lubricant is included in an amount between about 0.5 wt % and about 3.0 wt % of the formulation.

51. The method of claim 36, wherein compressibility of the supplement is between about 22 kp and about 40 kp.

52. The method of claim 36, wherein compressibility of the supplement is about 23.7 kp.

53. The method of claim 36, wherein compressibility of the supplement is increased by at least 100% when compared to traditional methods.
